(19) United States
(12) Patent Application Publication
(10) Pub. No.: US 2013/0170732 A1
(43) Pub. Date: Jul. 4, 2013

(54) MEDICINE PACK INSPECTING SYSTEM

(71) Applicants: Makoto Gotou, Hyogo (JP); Takanobu Tanimoto, Osaka (JP); Yoshihiko Matsukawa, Nara (JP); Tomoyuki Shindo, Kyoto (JP)

(72) Inventors: Makoto Gotou, Hyogo (JP); Takanobu Tanimoto, Osaka (JP); Yoshihiko Matsukawa, Nara (JP); Tomoyuki Shindo, Kyoto (JP)

(21) Appl. No.: 13/822,737

(22) PCT Filed: Jul. 4, 2012
(86) PCT No.: PCT/JP2012/004321

§ 371 Date: Mar. 13, 2013

(30) Foreign Application Priority Data
Aug. 8, 2011 (JP) 2011-172779

(51) Int. Cl. G06T 7/00

(52) U.S. Cl. CPC G06T 7/0012
USPC 382/141

(57) ABSTRACT

A medicine pack inspecting system includes a packing instruction unit that generates packing instruction information, a tablet packing unit that encloses tablets in a medicine pack, an image capturing unit that generates a medicine pack image, and a tablet inspecting unit that inspects the number of tablets enclosed in the medicine pack by performing pattern matching using the medicine pack image and a tablet pattern shown in the packing instruction information, wherein when the packing instruction information includes information on an irregular shaped tablet, the tablet inspecting unit inspects the number of an irregular shaped tablet by performing pattern matching using an irregular shaped tablet pattern of the irregular shaped tablet and the medicine pack image.

### TECHNICAL FIELD

The present invention relates to medicine pack inspecting systems for inspecting medicine packs in which tablets are enclosed.

### BACKGROUND ART

In hospitals and pharmacies, tablets are packed in medicine packs according to a prescription, and delivered to a patient as the medicine packs. At this time, a pharmacist visually checks whether the tablets are correctly enclosed in the medicine packs according to the prescription. However, work load is heavy for the pharmacist because the pharmacist visually checks a large number of the medicine packs in a short time. For this reason, methods have been proposed in which inspection of the medicine packs is assisted by mechanically counting the number of tablets packed in the medicine pack (see Patent Literature (PTL) 1, for example).

FIG. 18 is a perspective view of a conventional medicine pack inspecting system 1 according to PTL 1. The medicine pack inspecting system 1 includes a camera 3 that photographs a medicine pack 2 located at an inspection position, a lighting unit 6 arranged under the camera 3, an image processing unit 4 that performs image processing on a gray-scale transmission image photographed by the camera 3, and a monitor 5 connected to the image processing unit 4.

The image processing unit 4 reads the transmission image photographed by the camera 3, and binarizes the transmission image at a predetermined threshold to obtain a binary image. Namely, the image processing unit 4 creates a binary image wherein a pixel having a luminance greater than the threshold is a white pixel and a pixel having a luminance equal to or less than the threshold is a black pixel. The image processing unit 4 performs erosion and dilation on the binary image to remove noise in the binary image, and generates an inspection image. In the inspection image, the image processing unit 4 takes a white region larger than a predetermined size left (a group of white pixels) as a tablet region, and detects the number of tablets by detecting the number of tablet regions. Then, the image processing unit 4 determines whether the detected number of tablets is equal to the total number of the tablets to be enclosed in a medicine pack. Thus, the medicine pack inspecting system 1 inspects the medicine pack by counting the number of tablets included in the medicine pack.

Moreover, PTL 2 discloses a tablet inspecting apparatus for detecting the number of tablets for each kind of the tablets.

### CITATION LIST

### Patent Literature

[PTL 1] Japanese Unexamined Patent Application Publication No. 9-231342
[PTL 2] Japanese Unexamined Patent Application Publication No. 2000-135268

### SUMMARY OF INVENTION

### Technical Problem

The medicine pack inspecting system 1 described in PTL 1 checks the number of tablet regions within the inspection image of the medicine pack. Depending on the prescription, to properly adjust an amount of dose for a patient, a regular shaped tablet is divided in half or quarters to prepare an irregular shaped tablet. The irregular shaped tablet is formulated as ½ or ¼ of the tablet.

The medicine pack inspecting system 1 detects only the number of tablet regions, however. For this reason, when the irregular shaped tablet is formulated, the regular shaped tablet may be packed in the medicine pack and formulated by mistake in spite of the case where an irregular shaped tablet divided in half or quarters should be formulated. If the regular shaped tablet is formulated by mistake instead of the irregular shaped tablet, the amount of dose for the patient doubles or quadruples. This mistake may cause a significant health problem.

Similarly to the case of PTL 1, PTL 2 dose not detect the number of irregular shaped tablets. For this reason, when the irregular shaped tablet is formulated, the accurate number of the tablets is difficult to detect.

The present invention has been made in order to solve the problems above. An object of the present invention is to provide a medicine pack inspecting system that inspects a medicine pack including tablets to attain accurate inspection of the tablets including a shape of an irregular shaped tablet.

### Solution to Problem

In order to solve the problems above, the medicine pack inspecting system according to the present invention is a medicine pack inspecting system including: a packing instruction unit configured to generate packing instruction information indicating the number of tablets of each kind to be enclosed in a medicine pack; a tablet packing unit configured to enclose tablets in the medicine pack based on the packing instruction information; an image capturing unit configured to capture an image of the medicine pack with the tablets being enclosed, to generate a medicine pack image; and a tablet inspecting unit configured to inspect the number of tablets enclosed in the medicine pack by performing pattern matching using the medicine pack image and a tablet pattern shown in the packing instruction information, the tablet pattern being a shape pattern of a tablet to be enclosed in the medicine pack, wherein when the packing instruction information includes information on an irregular shaped tablet which is a tablet divided based on the packing instruction information, the tablet inspecting unit is configured to inspect the number of the irregular shaped tablets by performing pattern matching using an irregular shaped tablet pattern as a shape pattern of the irregular shaped tablet and the medicine pack image.

These general or specific aspects may be implemented by a system, a method, an integrated circuit, a computer program, or a recording medium, or may be implemented by any combination of the system, the method, the integrated circuit, the computer program, and the recording medium.

### Advantageous Effects of Invention

The present invention can provide a medicine pack inspecting system that inspects a medicine pack including tablets to attain accurate inspection of the tablets including a shape of an irregular shaped tablet.

### BRIEF DESCRIPTION OF DRAWINGS

FIG. 1 FIG. 1 is a schematic view showing a configuration of a medicine pack inspecting system according to Embodiment 1 of the present invention.

FIG. 2A is a drawing showing prescription information according to Embodiment 1 of the present invention.

FIG. 2B is a drawing showing packing instruction information according to Embodiment 1 of the present invention.

FIG. 2C is a drawing showing packing pattern information according to Embodiment 1 of the present invention.

FIG. 3 is a flowchart showing a method of inspecting a medicine pack in a medicine pack inspecting system according to Embodiment 1 of the present invention.

FIG. 4 is a flowchart showing detailed steps in an inspection step according to Embodiment 1 of the present invention.

FIG. 5A is a drawing showing a regular, disk-shaped tablet according to Embodiment 1 of the present invention.

FIG. 5B is a drawing showing an example of an irregular shaped tablet obtained by dividing the regular, disk-shaped tablet according to Embodiment 1 of the present invention.

FIG. 5C is a drawing showing an example of another irregular shaped tablet obtained by dividing the regular, disk-shaped tablet according to Embodiment 1 of the present invention.

FIG. 5D is a drawing showing a regular, oval-shaped tablet according to Embodiment 1 of the present invention.

FIG. 5E is a drawing showing an example of an irregular shaped tablet obtained by dividing the regular, oval-shaped tablet according to Embodiment 1 of the present invention.

FIG. 5F is a drawing showing an example of another irregular shaped tablet obtained by dividing the regular, oval-shaped tablet according to Embodiment 1 of the present invention.

FIG. 6 is a drawing showing tablets included in a medicine pack according to Embodiment 1 of the present invention.

FIG. 7 is a drawing showing a medicine pack image for search according to Embodiment 1 of the present invention.

FIG. 8 is a drawing showing a medicine pack image for search in an inspection process according to Embodiment 1 of the present invention.

FIG. 9 is a drawing showing another medicine pack image for search in the inspection process according to Embodiment 1 of the present invention.

FIG. 10 is a drawing showing further another medicine pack image for search in the inspection process according to Embodiment 1 of the present invention.

FIG. 11 is a drawing showing a medicine pack image for search according to Embodiment 1 of the present invention, which includes a broken tablet region.

FIG. 12 is a drawing showing a medicine pack image for search in the inspection process according to Embodiment 1 of the present invention, in which a broken tablet region is included.

FIG. 13 is a flowchart showing detailed steps in an inspection step according to Embodiment 2 of the present invention.

FIG. 14 is a drawing showing packing pattern information according to Embodiment 2 of the present invention.

FIG. 15 is a drawing showing a medicine pack image for search according to Embodiment 2 of the present invention.

FIG. 16 is a drawing showing a medicine pack image for search in the inspection process according to Embodiment 2 of the present invention.

FIG. 17 is a drawing showing another medicine pack image for search in the inspection process according to Embodiment 2 of the present invention.

FIG. 18 is a perspective view showing the conventional medicine pack inspecting system.

### DESCRIPTION OF EMBODIMENTS

Hereinafter, embodiments according to the present invention will be described with reference to the drawings. Same referential numerals will be given to same components, and the description may be omitted. The respective components are schematically shown in the drawings to facilitate the understanding of these components.

The embodiments to be described below show only specific examples of the present invention. Numeral values, shapes, materials, components, arrangements, positions, and connection forms of the components, steps, order of the steps, and the like shown in the embodiments below are only examples, and will not limit the present invention. Moreover, among the components of the embodiments below, the components not described in an independent claim representing the most superordinate concept of the present invention will be described as arbitrary components.

### Embodiment 1

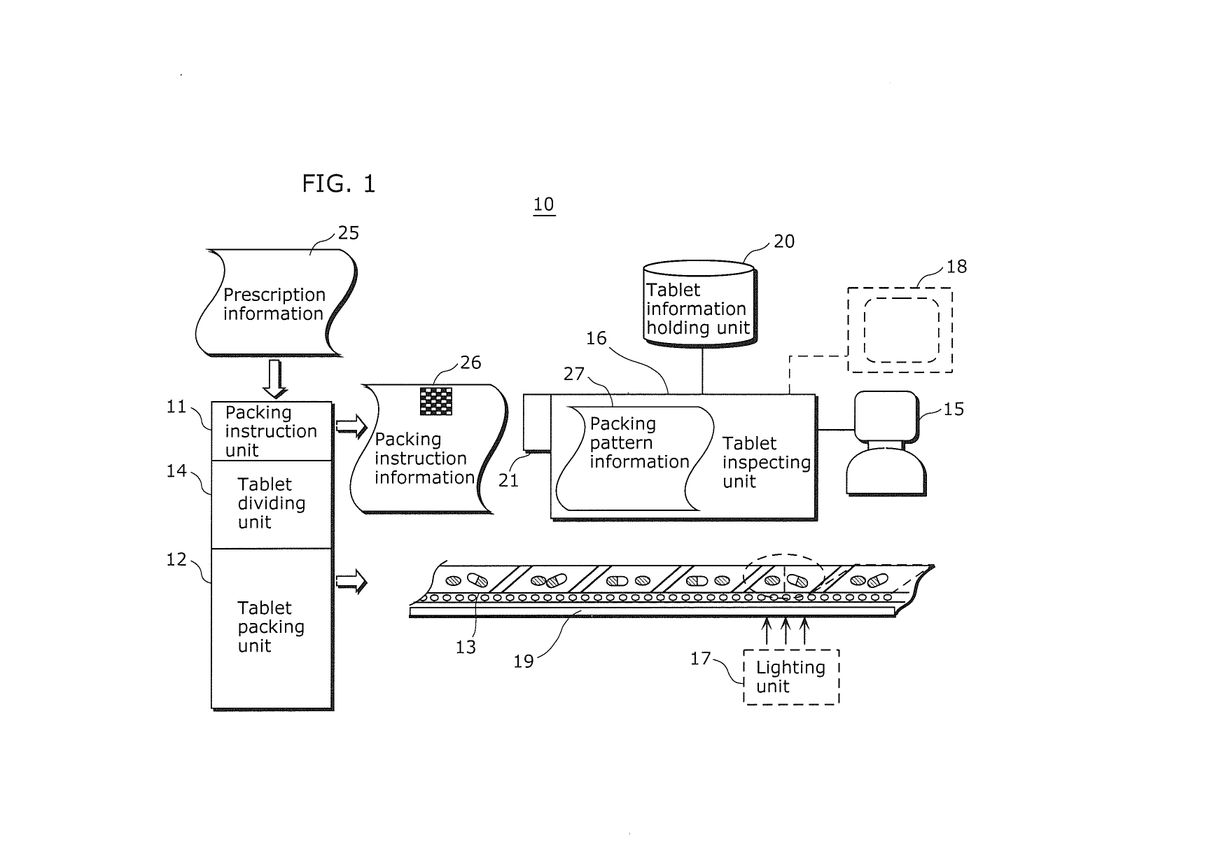

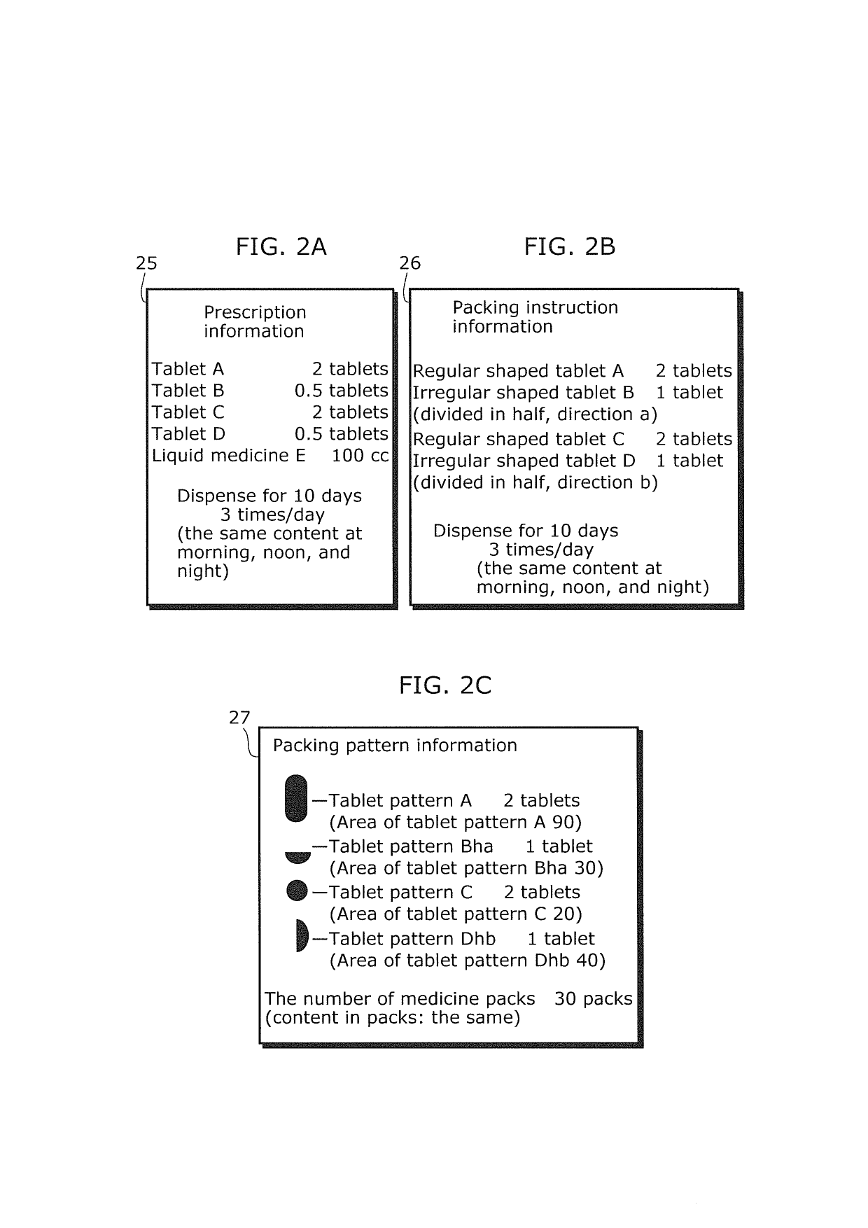

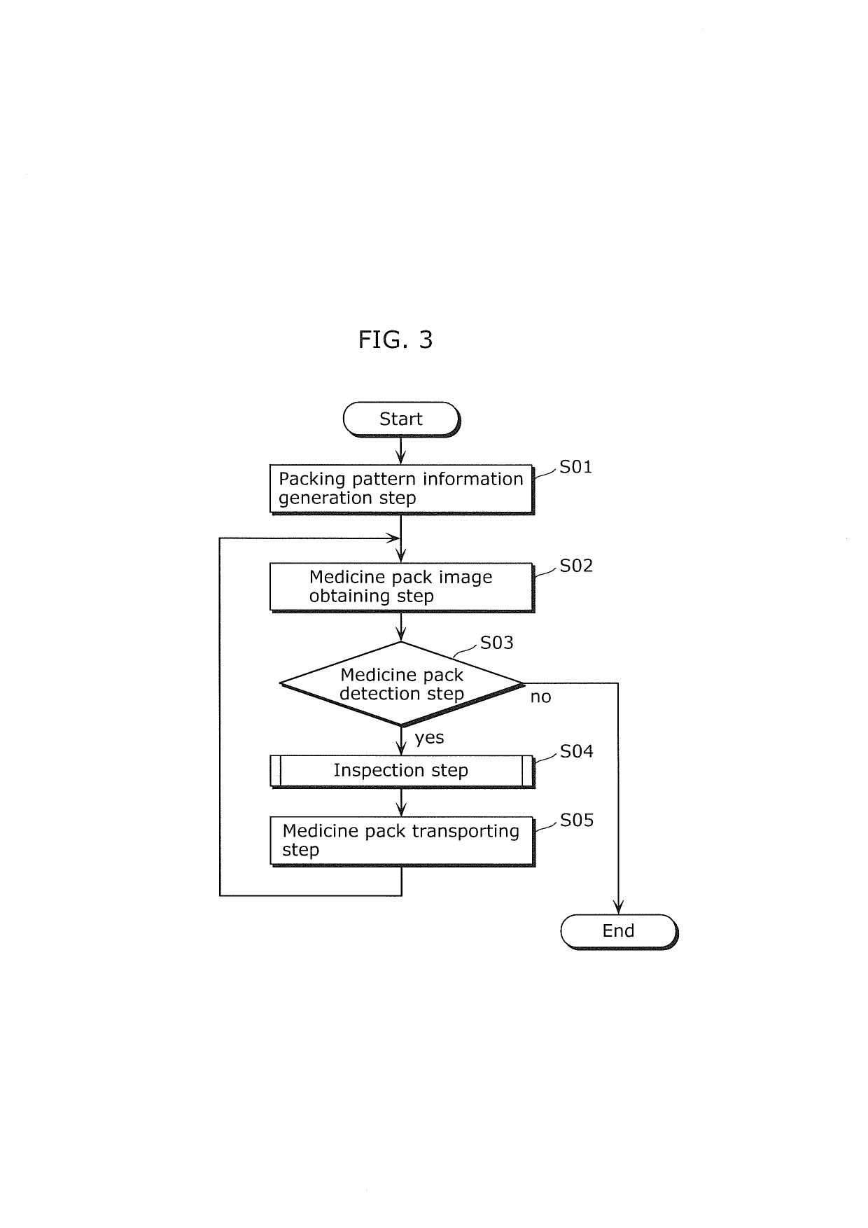

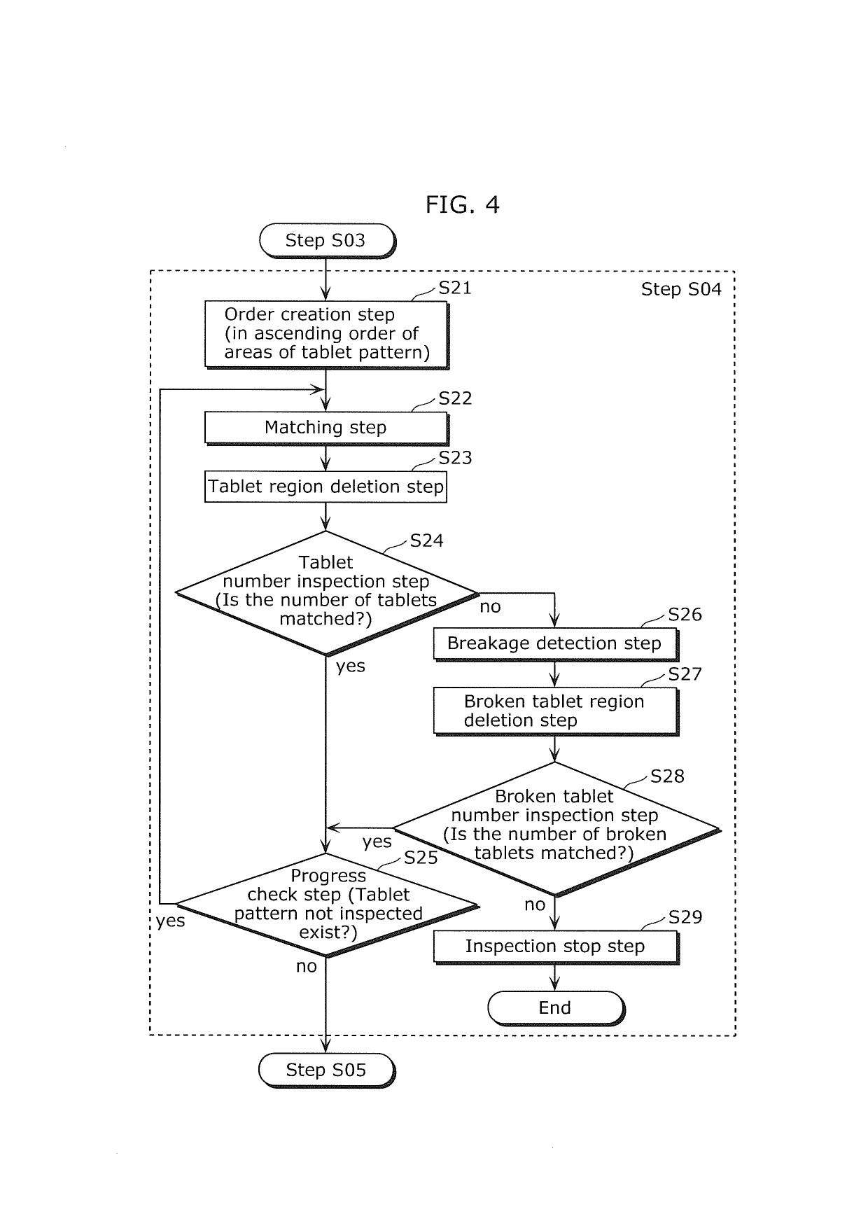

FIG. 1 is a schematic view of a configuration of a medicine pack inspecting system 10 according to Embodiment 1 of the present invention. FIG. 2A to FIG. 2C are drawings for describing a variety of contents of information according to Embodiment 1. FIG. 2A shows prescription information, FIG. 2B shows packing instruction information, and FIG. 2C shows packing pattern information. FIG. 3 is a flowchart showing a method of inspecting a medicine pack in the medicine pack inspecting system 10. FIG. 4 is a flowchart showing detailed steps in an inspection step S04 in FIG. 3.

The medicine pack inspecting system 10 shown in FIG. 1 includes a packing instruction unit 11, a tablet packing unit 12 that encloses tablets in a medicine pack 13, a tablet dividing unit 14, an image capturing unit 15, a tablet inspecting unit 16, and a tablet information holding unit 20 that holds tablet information. The medicine pack inspecting system 10 further includes a lighting unit 17 that illuminates the medicine pack 13, a display unit 18, a transporting unit 19 that transports the medicine pack 13, and a code input unit 21 that reads and inputs a two-dimensional code or the like in the medicine pack 13.

In the medicine pack inspecting system 10, a regular shaped tablet is divided in half or quarters in the tablet dividing unit 14 to form an irregular shaped tablet. The irregular shaped tablet is enclosed in the medicine pack 13, and it is inspected whether the irregular shaped tablet is properly contained in the medicine pack 13 after enclosing the tablets. Here, the regular shaped tablet refers to a disk-shaped tablet, an oval-shaped tablet, and the like. The irregular shaped tablet refers to a tablet obtained by dividing the regular shaped tablet in the tablet dividing unit 14. Here, in the tablet dividing unit 14, the regular shaped tablet is cut using a cutting tool not shown or the like to divide the regular shaped tablet in half or quarters according to packing instruction information 26 described later and produce the irregular shaped tablet. In the present embodiment, the case where the regular shaped tablet is divided by the tablet dividing unit 14 will be described, but a pharmacist may divide the regular shaped tablet by hand, for example, according to the packing instruction information 26 described later to produce the irregular shaped tablet.

Based on prescription information 25, the packing instruction unit 11 calculates the kinds and the number of tablets taken by the patient at one time, and generates the packing instruction information 26. Namely, the packing instruction information 26 indicates tablet patterns which are shape patterns of the tablets to be enclosed in the medicine pack 13. Here, the prescription information 25 refers to the information indicating the content of a prescription created by a doctor, a pharmacist, or the like. The prescription information 25 includes the information indicating medicines to be given to the patient, the amount of dose, and the like. The packing instruction unit 11 electronically generates the packing instruction information 26 from the prescription information 25. For example, the packing instruction unit 11 extracts only the information on prescription of the tablet from the prescription information 25 shown in FIG. 2A, and generates the packing instruction information 26 shown in FIG. 2B. Alternatively, the packing instruction information may be generated by a doctor, a pharmacist, or the like.

The packing instruction information 26 shown in FIG. 2B means that two regular shaped tablets A, one irregular shaped tablet B (divided in half, in the direction a), two regular shaped tablets C, and one irregular shaped tablet D (divided in half, in the direction b) are enclosed in one medicine pack. Further, the packing instruction information 26 means that the tablets are to be taken 3 times a day (the same content is to be taken at morning, noon, and night) for 10 days and the number of the medicine packs 13 for the number of tablets above is to be produced. Here, the irregular shaped tablet B (divided in half, in the direction a) means an irregular shaped tablet obtained by dividing the regular shaped tablet B in half in the direction a using the tablet dividing unit 14, which will be described later. The irregular shaped tablet D (divided in half, in the direction b) means an irregular shaped tablet obtained by dividing the regular shaped tablet D in half in the direction b using the tablet dividing unit 14, which will be described later. According to the packing instruction information 26, the number of the medicine packs 13 is 10 days×3 times=30 packs. The packing instruction unit 11 gives the information on the irregular shaped tablet indicating the number of divisions and the direction of division, and generates the packing instruction information 26.

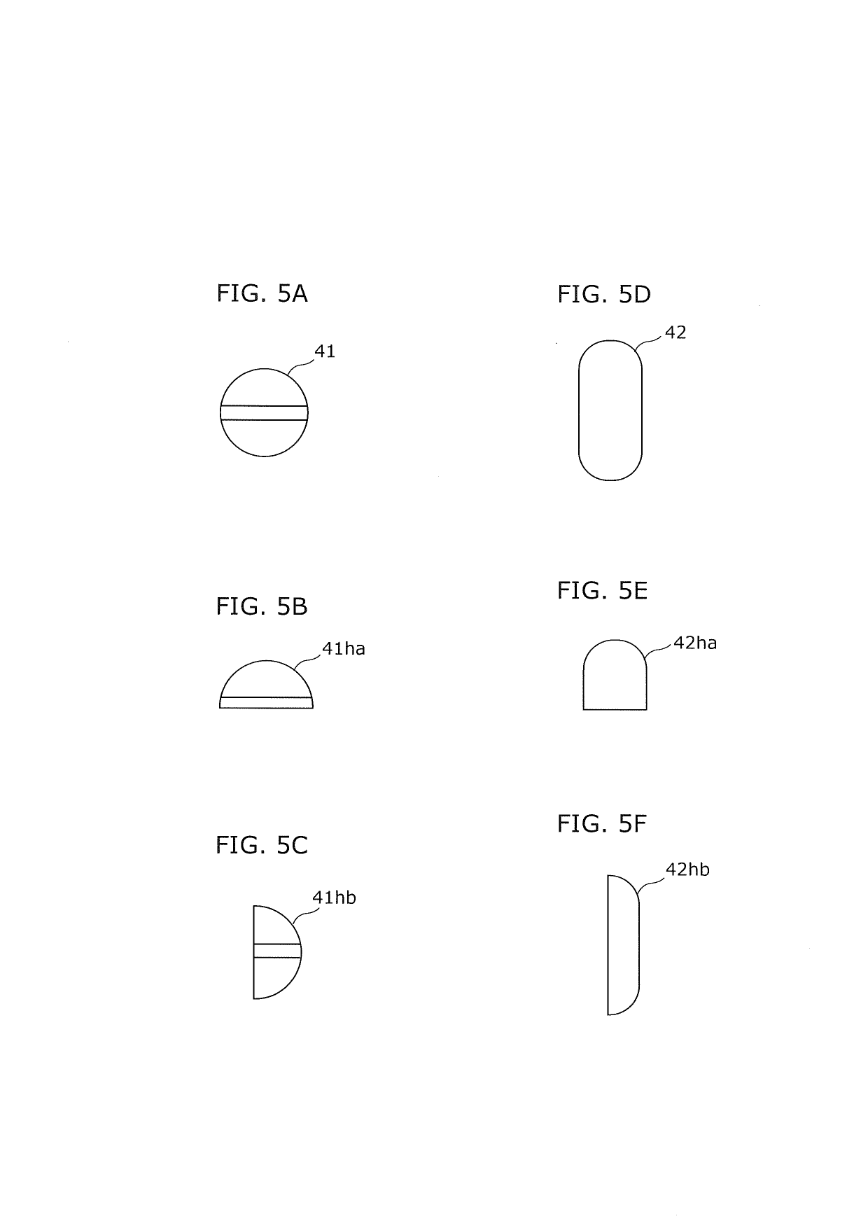

FIG. 5A to FIG. 5F are drawings showing examples of the shapes of the regular shaped tablets and the irregular shaped tablets. FIG. 5A is a drawing showing a shape of a regular, disk-shaped tablet 41. FIG. 5B is a drawing showing a shape of an irregular shaped tablet 41ha obtained by dividing the regular shaped tablet 41 in half in the direction a. FIG. 5C is a drawing showing a shape of an irregular shaped tablet 41hb obtained by dividing the regular shaped tablet 41 in half in the direction b. Here, the regular shaped tablet 41 has the disk shape with a linear depression. The irregular shaped tablet 41ha divided in half in the direction a is obtained by dividing the regular shaped tablet 41 along the linear depression while the irregular shaped tablet 41hb divided in half in the direction b is obtained by dividing the regular shaped tablet 41 perpendicularly to the linear depression. FIG. 5D is a drawing showing the shape of a regular, oval-shaped tablet 42. FIG. 5E is a drawing showing the shape of the irregular shaped tablet 42ha obtained by dividing the regular shaped tablet 42 in half in the direction a. FIG. 5F is a drawing showing the shape of an irregular shaped tablet 42hb obtained by dividing the regular shaped tablet 42 in half in the direction b. The irregular shaped tablet 42ha divided in half in the direction a is obtained by dividing the regular shaped tablet 42 along the short axis while the irregular shaped tablet 42hb divided in half in the direction b is obtained by dividing the regular shaped tablet 42 along the long axis.

The tablet dividing unit 14 shown in FIG. 1 produces the instructed irregular shaped tablet according to the packing instruction information 26 from the packing instruction unit 11. The tablet packing unit 12 produces the medicine pack 13 in which the instructed irregular shaped tablet and the regular shaped tablet are enclosed. To produce the medicine pack 13, for example, the tablet dividing unit 14 divides the regular shaped tablet B in half in the direction a to produce the irregular shaped tablet B, and divides the regular shaped tablet D in half in the direction b to produce the irregular shaped tablet D. Subsequently, the tablet packing unit 12 gravitationally drops one irregular shaped tablet B, one irregular shaped tablet D, two regular shaped tablets A, and two regular shaped tablets C together into the same medicine pack 13, and seals the medicine pack 13 by heat sealing. This operation is repeated, and the medicine pack 13 having several tablets enclosed between two films is continuously produced. Here, 30 medicine packs 13 are continuously produced to form a series of medicine packing sheet.

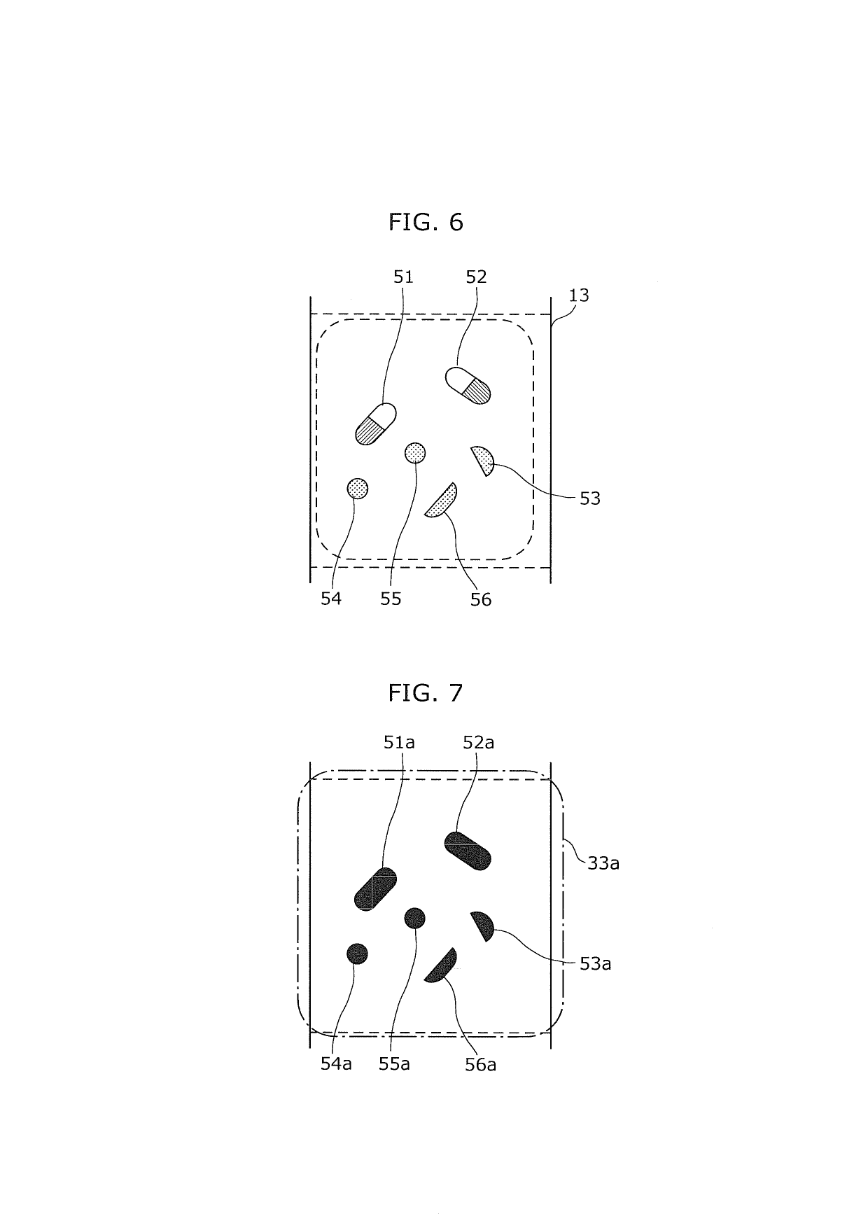

FIG. 6 is a drawing showing the tablets enclosed in the medicine pack 13. In the drawing, the regular shaped tablets A designated by referential numerals 51 and 52 have the oval shape shown in FIG. 5D. In the drawing, the irregular shaped tablet B designated by referential numeral 53 has the shape shown in FIG. 5B, which is obtained by dividing the regular, disk-shaped tablet B in half in the direction a. In the drawing, the regular shaped tablets C designated by referential numerals 54 and 55 have the disk shape shown in FIG. 5A. In the drawing, the irregular shaped tablet D designated by referential numeral 56 has the shape shown in FIG. 5F, which is obtained by dividing the regular, oval-shaped tablet D in half in the direction b.

The tablet packing unit 12 shown in FIG. 1 produces the medicine pack 13 in which the necessary tablets are enclosed according to the packing instruction information 26 from the packing instruction unit 11. The packing instruction unit 11 outputs a sheet of the packing instruction information 26. The sheet has a printed bar code obtained by two-dimensionally coding the packing instruction information 26. Details of the packing instruction information 26 are also printed on the sheet of the packing instruction information 26 at the same time, and used as master information when the medicine pack 13 is checked manually. The sheet of the packing instruction information 26 is transported mechanically or manually to the tablet inspecting unit 16. The medicine packing sheet formed of the medicine packs 13 is transported mechanically or manually to the transporting unit 19.

A code input unit 21 is attached to the tablet inspecting unit 16 shown in FIG. 1. The code input unit 21 inputs the packing instruction information 26 to the tablet inspecting unit 16. The packing instruction information 26 is obtained by mechanically or manually reading the two-dimensional code printed on the sheet of the packing instruction information 26. Referring to regular shaped tablet information held in the tablet information holding unit 20 which indicates the regular shaped tablet information for each of the tablets included in the packing instruction information 26, the tablet inspecting unit 16 produces packing pattern information 27 corresponding to the packing instruction information 26. For example, the packing pattern information 27 is the information including the tablet patterns and the areas of the tablet patterns. The tablet patterns are the tablet shape patterns of the regular shaped tablet A, the irregular shaped tablet B, the regular shaped tablet C, and the irregular shaped tablet D. The tablet information holding unit 20 holds the regular shaped tablets patterns, which are patterns of regular shapes of various tablets, and the accompanying information (such as the area and color).

An example of the packing pattern information 27 is shown in FIG. 2C. First, based on the packing instruction information 26, the tablet inspecting unit 16 reads a tablet pattern A indicating the tablet pattern of the regular shaped tablet A and a value of 90 mm² indicating the area of the tablet pattern A from the tablet information holding unit 20. Then, the tablet inspecting unit 16 sets the tablet pattern A, the number of tablets at 2, and the value of the area of the tablet pattern A at 90 mm² in the packing pattern information 27. Here, the value of the area of the tablet pattern A corresponds to a projected area (mm×mm) of the regular shaped tablet A when the regular shaped tablet is seen from above, and can be converted into an area of a region in the medicine pack image described later.

Moreover, based on the packing instruction information 26, the tablet inspecting unit 16 reads a tablet pattern B indicating the tablet pattern of the regular shaped tablet B and a value of 60 mm² indicating the area of the tablet pattern B from the tablet information holding unit 20, and produces a tablet pattern Bha of the irregular shaped tablet B (divided in half, in the direction a). Then, the tablet inspecting unit 16 obtains the value of 30 mm² as the area of the tablet pattern Bha of the tablet pattern Bha, and set the tablet pattern Bha, the number of tablets at 1, and the value of the area of the tablet pattern Bha at 30 mm² in the packing pattern information 27. Here, the tablet pattern Bha of the irregular shaped tablet B is produced by dividing the tablet pattern B of the regular shaped tablet B in half in the direction a, and the value of the area of the tablet pattern Bha is obtained by multiplying the area of the tablet pattern B of 60 mm² by ½.

Moreover, based on the packing instruction information 26, the tablet inspecting unit 16 reads a tablet pattern C as the tablet pattern of the regular shaped tablet C, the number of tablets of 2, and a value of 20 mm² as the area of the tablet pattern C from the tablet information holding unit 20, and sets the tablet pattern C, the number of tablets, and the area of the tablet pattern C in the packing pattern information 27.

Moreover, based on the packing instruction information 26, the tablet inspecting unit 16 reads a tablet pattern D indicating the tablet pattern of the regular shaped tablet D and a value of 80 mm² indicating the area of the tablet pattern D from the tablet information holding unit 20, and produces a tablet pattern Dhb of the irregular shaped tablet D (divided in half, in the direction b). Then, the tablet inspecting unit 16 obtains the value of 40 mm² as the area of the tablet pattern Dhb, and sets the tablet pattern Dhb, the number of tablets at 1, and the value indicating the area of the tablet pattern Dhb at 40 mm² in the packing pattern information 27. Here, the tablet pattern Dhb of the irregular shaped tablet D is produced by dividing the tablet pattern D of the regular shaped tablet D in half in the direction b, and the value of the area of the tablet pattern Dhb is produced by multiplying the area of the tablet pattern D of 80 mm² by ½

Moreover, the packing instruction information 26 indicates that the number of days is for 10 days, and the tablets are to be taken 3 times/day (the same content is to be taken at morning, noon, and night). Based on the packing instruction information 26, the tablet inspecting unit 16 sets the number of the medicine packs at 30 and the same tablets for each of the medicine packs in the packing pattern information 27.

The medicine pack 13 shown in FIG. 1 is placed on the transporting unit 19 mechanically or manually. The image capturing unit 15 captures an image of the medicine pack 13 irradiated with light from the lighting unit 17, and transmits the captured image to the tablet inspecting unit 16. The tablet inspecting unit 16 produces a medicine pack image 33a from the image captured by the image capturing unit 15. The medicine pack image 33a corresponds to the medicine pack 13. An example of the medicine pack image 33a is shown in FIG. 7. The tablet inspecting unit 16 outputs the medicine pack image 33a to the display unit 18 when necessary.

Here, the lighting unit 17 is located on the opposite side of the image capturing unit 15 with the medicine pack 13 being interposed between the lighting unit 17 and the image capturing unit 15. Accordingly, the image captured by the image capturing unit 15 is a transmission image of the medicine pack 13. For this reason, the image captured by the image capturing unit 15 is a gray-scale image in which the portion of the tablet enclosed in the medicine pack 13 is a black region (namely, a pixel region having low luminance). When necessary, the tablet inspecting unit 16 may perform noise reduction or binarization on the image captured by the image capturing unit 15, and produce the medicine pack image 33a. In the description below, the tablet region is the black region, but black and white of the medicine pack image 33a may be inverted and the tablet region may be a white region (namely, a pixel region having high luminance).

The tablet inspecting unit 16 detects the irregular shaped tablets included within the medicine pack image 33a, and inspects the irregular shaped tablets including the shapes of the irregular shaped tablets. This will be described with reference to the drawings.

A flowchart showing an inspection method performed by the tablet inspecting unit 16 is shown in FIG. 3.

First, a packing pattern information generation step S01 in FIG. 3 will be described.

In the packing pattern information generation step S01, the packing instruction information 26 is input via data communication or manually using a keyboard, for example, from the code input unit 21. Referring to the regular shaped tablet information held in the tablet information holding unit 20, the tablet inspecting unit 16 produces the packing pattern information 27 based on the packing instruction information 26. For example, as shown in FIG. 2C, in correspondence with the regular shaped tablet A in the packing instruction information 26, the tablet inspecting unit 16 produces the packing pattern information 27 from the tablet pattern A, the number of tablets, and the value of the area of the tablet pattern A. Moreover, in correspondence with the irregular shaped tablet B in the packing instruction information 26, the tablet inspecting unit 16 adds the tablet pattern Bha, the number of tablets, and the value of the area of the tablet pattern Bha to the packing pattern information 27. Similarly, in correspondence with the regular shaped tablet C in the packing instruction information 26, the tablet inspecting unit 16 adds the tablet pattern C, the number of tablets, and the area of the tablet pattern C to the packing pattern information 27. Similarly, in correspondence with the irregular shaped tablet D in the packing instruction information 26, the tablet inspecting unit 16 adds the tablet pattern Dhb, the number of tablets, and the value of the area of the tablet pattern Dhb to the packing pattern information 27. In correspondence with the packing instruction information 26, the tablet inspecting unit 16 also adds the information indicating the number of medicine packs of 30 and the same tablets for each of the medicine packs to the packing pattern information 27.

Subsequently, a medicine pack image obtaining step S02 in FIG. 3 will be described.

In the medicine pack image obtaining step S02, the image capturing unit 15 captures an image of the medicine pack 13 illuminated by the lighting unit 17, and transmits the captured image to the tablet inspecting unit 16. The tablet inspecting unit 16 obtains the image captured by the image capturing unit 15, and displays the captured image on the display unit 18 when necessary. The timing of the image capturing by the image capturing unit 15 is controlled from the tablet inspecting unit 16.

Subsequently, a medicine pack detection step S03 in FIG. 3 will be described.

In the medicine pack detection step S03, the tablet inspecting unit 16 extracts the region of the medicine pack 13 from the image captured by the image capturing unit 15, and produces the medicine pack image 33a. An example of the medicine pack image 33a is shown in FIG. 7. The tablet inspecting unit 16 detects the boundary of the medicine pack 13 from perforation provided between the medicine packs 13 or the like, and produces the medicine pack image 33a corresponding to one medicine pack 13. When the tablet inspecting unit 16 can detect the medicine pack 13 in the image captured by the image capturing unit 15 (yes in Step S03), the processing goes to an inspection step S04. When the tablet inspecting unit 16 cannot detect the medicine pack 13 in the image captured by the image capturing unit 15 (no in Step S03), the inspection processing is terminated. The region of the medicine pack 13 may be extracted by marking individual medicine packs 13 and detecting the mark.

Subsequently, the inspection step S04 in FIG. 3 will be described.

In the inspection step S04, the tablet inspecting unit 16 inspects the tablets included within the medicine pack image 33a and the shapes of the irregular shaped tablets. FIG. 4 is a flowchart showing the detailed steps of the inspection step S04. The flowchart in FIG. 4 will be specifically described later. In the tablet inspecting unit 16, when the inspection step S04 is completed, the processing goes to a medicine pack transporting step S05.

Subsequently, a medicine pack transporting step S05 in FIG. 3 will be described.

In the medicine pack transporting step S05, the tablet inspecting unit 16 controls the transporting unit 19, transports the medicine pack 13 by one pack in the right direction of FIG. 1, and stop the transporting unit 19. The medicine pack 13 is transported, for example, by engaging a sprocket (not shown) with holes formed on one end surface of the medicine pack 13 and rotating the sprocket by a predetermined angle using the transporting unit 19. When the transporting unit 19 transports only one medicine pack 13, the processing returns to the medicine pack image obtaining step S02, and the tablet inspecting unit 16 executes the medicine pack image obtaining step S02. The medicine pack 13 may be marked, and transported to a position in which the mark on the medicine pack may be detected by a sensor provided in the transporting unit 19. Using the thus-configured transporting unit 19, the tablet inspecting unit 16 can inspect the medicine packs 13 one by one in which the irregular shaped tablets are enclosed.

Next, the operation in the inspection step S04 will be specifically described with reference to the flowchart in FIG. 4.

An order creation step S21 in FIG. 4 will be described.

In the order creation step S21, the tablet inspecting unit 16 compares the areas of the tablet patterns included in the packing pattern information 27, and creates the order of the tablet patterns in an ascending order of areas of the tablet pattern. Moreover, the tablet inspecting unit 16 assigns inspection codes to the respective tablet patterns, and sets all the inspection codes at “not processed.” For example, in the example of the packing pattern information 27 shown in FIG. 2C, the tablet inspecting unit 16 produces the tablet pattern C of the regular shaped tablet C as the first tablet pattern, the tablet pattern Bha of the irregular shaped tablet B as the second tablet pattern, the tablet pattern Dhb of the irregular shaped tablet D as the third tablet pattern, and the tablet pattern A of the regular shaped tablet A as the fourth tablet pattern. Thus, the order of the tablet patterns is created. Then, the tablet inspecting unit 16 sets the inspection codes of the tablet pattern C, the tablet pattern Bha, the tablet pattern Dhb, and the tablet pattern A at “not processed.” In the present embodiment, according to Steps S22 to S28 executed in a loop, pattern matching is sequentially performed in the order of the tablet patterns created here.

Subsequently, a matching step S22 in FIG. 4 will be described.

In the matching step S22, first, referring to the order of the tablet patterns created in the order creation step S21, the tablet inspecting unit 16 selects the tablet pattern having the smallest area from the tablet patterns not inspected (namely, the tablet patterns having the inspection code of “not processed”). Thereby, a first tablet pattern to be subjected to pattern matching is selected. Using the selected tablet pattern, the tablet inspecting unit 16 performs the pattern matching within the medicine pack image for search, and searches an image region that matches with the pattern (here, the black region). The tablet inspecting unit 16 determines the pattern-matched image region as the tablet region having the selected tablet pattern. Here, when the patterns of several image regions are matched, the tablet inspecting unit 16 determines each of the image regions as the tablet region having the selected tablet pattern. Then, the tablet inspecting unit 16 counts the number of tablet regions having the selected tablet pattern.

Subsequently, a tablet region deletion step S23 in FIG. 4 will be described.

In the tablet region deletion step S23, the tablet inspecting unit 16 deletes the tablet region having the tablet pattern determined in the matching step S22 from the medicine pack image for search, and produces a new medicine pack image for search. The new medicine pack image for search is used for the subsequent pattern matching of the tablet pattern.

Subsequently, a tablet number inspection step S24 in FIG. 4 will be described.

In the tablet number inspection step S24, the tablet inspecting unit 16 compares the number of tablet regions counted in the matching step S22 with the number of tablet patterns for the pattern matching shown in the packing pattern information 27. When the number of tablet regions counted in the matching step S22 is equal to the number of tablet patterns for the pattern matching shown in the packing pattern information 27 (yes in Step S24), the tablet inspecting unit 16 changes the inspection code of the selected tablet pattern to “processed” in the matching step S22, and the processing goes to a progress check step S25. When the number of tablet regions counted in the matching step S22 is not equal to the number of tablet patterns for the pattern matching shown in the packing pattern information 27 (no in Step S24), namely, when the number of tablet regions is smaller than the number of tablet patterns, the tablet inspecting unit 16 calculates the number of missing tablets, and the processing goes to a breakage detection step S26.

Subsequently, the progress check step S25 in FIG. 4 will be described.

In the progress check step S25, the tablet inspecting unit 16 checks whether the tablet pattern not inspected exists or not. When it is determined that the tablet pattern having the inspection code of “not processed” exists (yes in Step S25), the processing returns to the matching step S22 in the loop. When it is determined that the tablet pattern having the inspection code of “not processed” does not exist (no in Step S25), the inspection of all the tablet patterns included in the packing pattern information 27 has been processed. Then, the processing goes to Step 505.

Subsequently, the breakage detection step S26 in FIG. 4 will be described.

In the breakage detection step S26, the tablet inspecting unit 16 uses the area of the selected tablet pattern as a reference area, detects a pixel region having an area smaller than the reference area within the medicine pack image for search (here, the black region) as a candidate for a broken tablet region, and searches for several candidates for the broken tablet region. A predetermined conversion ratio between the area units of the tablet pattern and the area units of the pixel region within the medicine pack image is set. Here, the conversion ratio is 1 for convenience of explanation. The tablet inspecting unit 16 determines an area of each of the detected candidates for the broken tablet region. The tablet inspecting unit 16 arbitrarily chooses two or more candidates from the several candidates for the broken tablet region, and sums up the areas of the chosen two or more candidates for the broken tablet region. When the total area is equal or approximately equal to the reference area of the selected tablet pattern, the tablet inspecting unit 16 determines the two or more candidates for the broken tablet region used for summing up as the broken tablet region for the tablet pattern, and counts the tablet region having the tablet pattern as one tablet region. When no candidate for a broken tablet region is found, the tablet inspecting unit 16 determines that the number of tablet regions having the tablet pattern is 0. Breakage of the tablet can be checked by synthesizing the shape of the two or more candidates for the broken tablet region used for summing up the area and performing the pattern matching between the synthesized shape and the selected tablet pattern. Moreover, when the number of missing tablets calculated in the tablet number inspection step S24 is 2, the tablet inspecting unit 16 can choose another two or more candidates for the broken tablet region from the several candidates for the broken tablet region, and determine the second tablet region of the tablet pattern from the total area or the synthesized shape.

Subsequently, the broken tablet region deletion step S27 in FIG. 4 will be described.

In the broken tablet region deletion step S27, the tablet inspecting unit 16 deletes the broken tablet region of the tablet pattern determined in the breakage detection step S26 from the medicine pack image for search, and produces a new medicine pack image for search. The new medicine pack image for search is used for the subsequent pattern matching of the tablet pattern.

Subsequently, a broken tablet number inspection step S28 in FIG. 4 will be described.

In the broken tablet number inspection step S28, the tablet inspecting unit 16 compares the number of tablet regions having the tablet pattern, which are counted in the breakage detection step S26, with the number of missing tablets calculated in the tablet number inspection step S24. When the number of tablet regions having the tablet pattern, which is counted in the breakage detection step S26, is equal to the number of missing tablets calculated in the tablet number inspection step S24 (yes in Step S28), the tablet inspecting unit 16 changes the inspection code of the tablet pattern to “processed.” Then, the processing goes to the progress check step S25. When the number of tablet regions having the tablet pattern, which is counted in the breakage detection step S26, is not equal to the number of missing tablets calculated in the tablet number inspection step S24 (no in Step S28), the processing goes to an inspection stop step S29.

Subsequently, the inspection stop step S29 in FIG. 4 will be described.

In the inspection stop step S29, the tablet inspecting unit 16 stops the inspection operation of the medicine pack 13, and displays an alarm on the display unit 18, for example.

Next, a series of operation from Steps S22 to S25 will be described with reference to FIG. 7 to FIG. 10. Within the medicine pack image 33a in FIG. 7, two tablet regions 51a and 52a corresponding to the regular shaped tablet A, one irregular shaped tablet region 53a corresponding to the irregular shaped tablet B, two tablet regions 54a and 55a corresponding to the regular shaped tablet C, and one irregular shaped tablet region 56a corresponding to the irregular shaped tablet D exist.

First, in the matching step S22, referring to the order created in the order creation step S21, the tablet inspecting unit 16 selects the tablet pattern having the smallest area from the tablet patterns having the inspection code of “not processed,” and selects the tablet pattern for pattern matching. In the present embodiment, first, the tablet inspecting unit 16 selects the first tablet pattern C having the smallest area of the tablet pattern as the tablet pattern for pattern matching. Using the tablet pattern C, the tablet inspecting unit 16 performs the pattern matching within the medicine pack image for search 33a in FIG. 7. In the matching step S22, the tablet inspecting unit 16 determines two black regions having a pattern matched with the tablet pattern C as the tablet regions 54a and 55a, counts the number of tablet regions 54a and 55a having the tablet pattern C, and obtains information that the number of tablet regions is 2

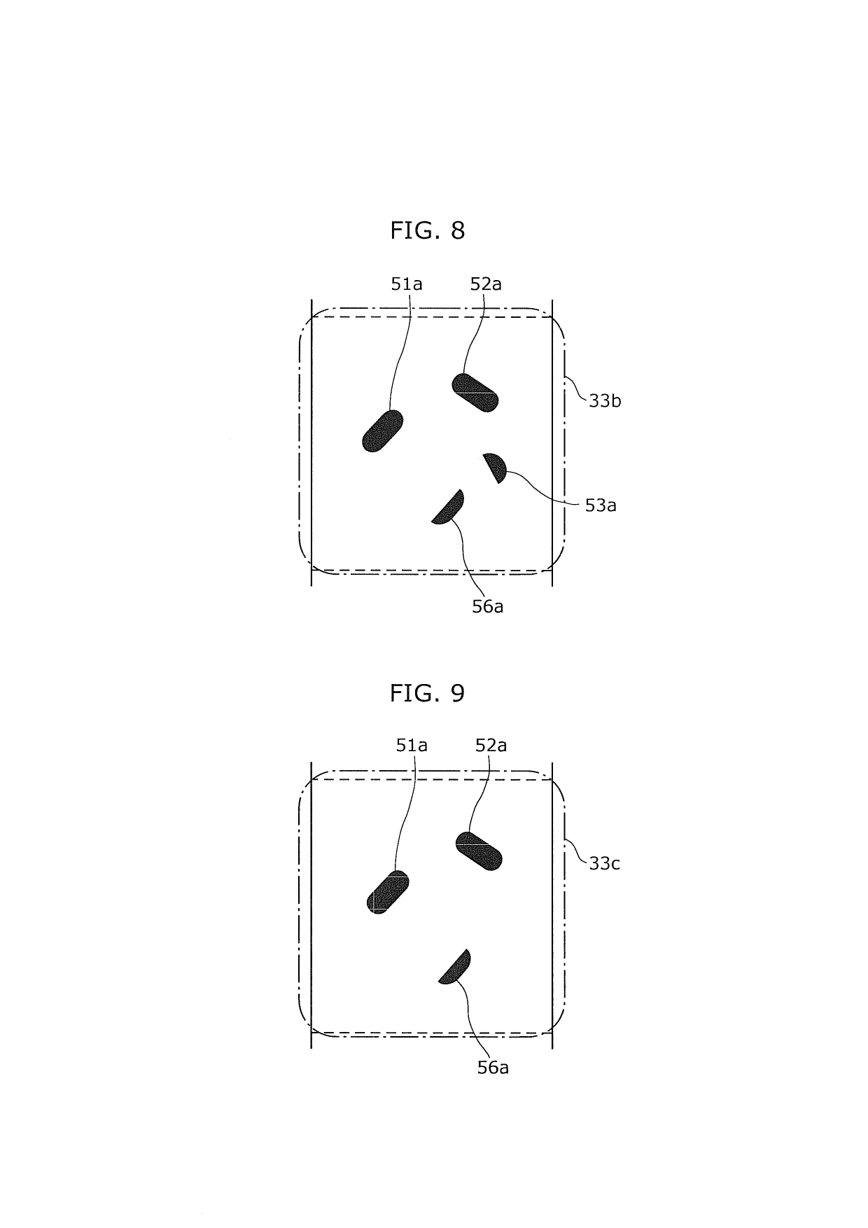

In the tablet region deletion step S23, the tablet inspecting unit 16 deletes the tablet regions 54a and 55a having the tablet pattern C, which are determined in the matching step S22, from the medicine pack image for search 33a, and produces a new medicine pack image for search 33b. The medicine pack image for search 33b is shown in FIG. 8. The medicine pack image for search 33b is used for the subsequent pattern matching of the tablet pattern.

In the tablet number inspection step S24, the tablet inspecting unit 16 compares the number of tablet regions having the tablet pattern C, which are counted in the matching step S22, with the number of tablet patterns C for the pattern matching shown in the packing pattern information 27, wherein the number of tablet regions is 2 and the number of tablet patterns C is 2. The number of tablet regions is equal to the number of tablet patterns C. Accordingly, the tablet inspecting unit 16 changes the inspection code of the regular shaped tablet pattern C from “not processed” to “processed.” Then, the processing goes to the progress check step S25.

In the progress check step S25, the tablet inspecting unit 16 checks whether the tablet pattern not inspected exists or not. Here, because the tablet pattern having the inspection code of “not processed” exists, the processing goes to the matching step S22.

In the second matching step S22, referring to the order created in the order creation step S21, the tablet inspecting unit 16 selects the tablet pattern Bha having the smallest area from the tablet patterns having the inspection code of “not processed,” and selects the tablet pattern Bha as the tablet pattern for the pattern matching. Using the tablet pattern Bha, the tablet inspecting unit 16 performs the pattern matching within the medicine pack image for search 33b in FIG. 8. In the matching step S22, the tablet inspecting unit 16 determines one black region having a pattern matched with the tablet pattern Bha as the irregular shaped tablet region 53a, counts the number of irregular shaped tablet regions 53a having the tablet pattern Bha, and obtains information that the number of irregular shaped tablet regions 53a is 1. In the tablet region deletion step S23, the tablet inspecting unit 16 deletes the irregular shaped tablet region 53a having the tablet pattern Bha, which is determined in the matching step S22, from the medicine pack image for search 33b, and produces a new medicine pack image for search 33c. The medicine pack image for search 33c is shown in FIG. 9. In the tablet number inspection step S24, the tablet inspecting unit 16 compares the number of tablet regions having the tablet pattern Bha with the number of tablet patterns Bha in the packing pattern information 27, wherein the number of tablet regions having the tablet pattern Bha is 1 and the number of tablets patterns Bha is 1. Here, the number of tablet regions having the tablet pattern Bha is equal to the number of tablet patterns Bha. Accordingly, the tablet inspecting unit 16 changes the inspection code of the tablet pattern Bha from “not processed” to “processed.” Then, the processing goes to the progress check step S25. In the progress check step S25, it is determined that the tablet pattern having the inspection code of “not processed” exists. Accordingly, the processing goes to the matching step S22.

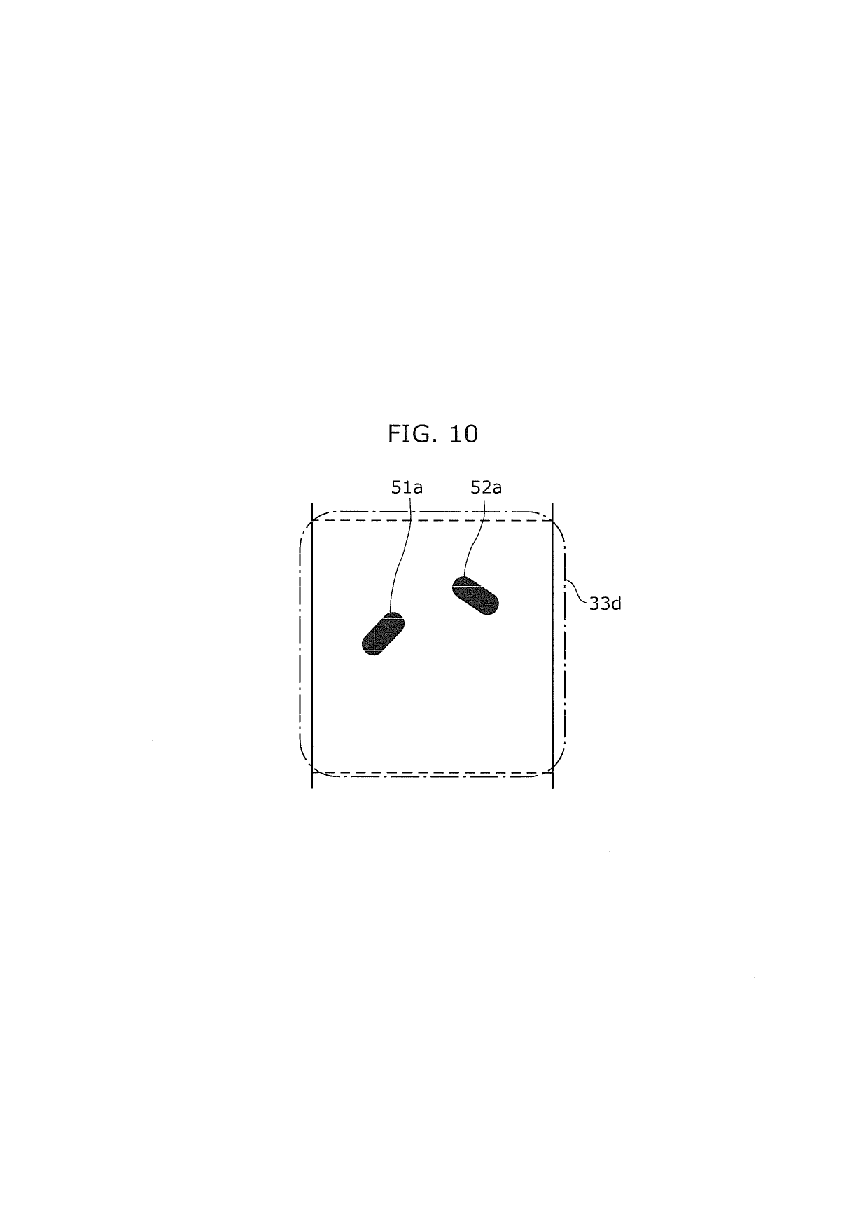

In the third matching step S22, referring to the order created in the order creation step S21, the tablet inspecting unit 16 selects the tablet pattern Dhb having the smallest area from the tablet patterns having the inspection code of “not processed” as the tablet pattern for pattern matching. Using the tablet pattern Dhb, the tablet inspecting unit 16 performs the pattern matching within in the medicine pack image for search 33c in FIG. 9. In the matching step S22, the tablet inspecting unit 16 determines one black region having a pattern matched with the tablet pattern Dhb as the irregular shaped tablet region 56a, counts the number of irregular shaped tablet regions 56a having the tablet pattern Dhb, and obtains information that the number of irregular shaped tablet regions 56a is 1. In the tablet region deletion step S23, the tablet inspecting unit 16 deletes the irregular shaped tablet region 56a having the tablet pattern Dhb, which is determined in the matching step S22, from the medicine pack image for search 33c, and produces a new medicine pack image for search 33d. The medicine pack image for search 33d is shown in FIG. 10. In the tablet number inspection step S24, the tablet inspecting unit 16 compares the number of tablet regions having the tablet pattern Dhb with the number of tablets patterns Dhb in the packing pattern information 27, wherein the number of tablet regions is 1 and the number of tablets patterns Dhb is 1. Here, the number of tablet regions having the tablet pattern Dhb is equal to the number of tablet patterns Dhb, the tablet inspecting unit 16 changes the inspection code of the tablet pattern Dhb from “not processed” to “processed.” Then, the processing goes to the progress check step S25. In the progress check step S25, it is determined that the tablet patterns having the inspection code of “not processed” exists. Accordingly, the processing goes to the matching step S22.

In the fourth matching step S22, referring to the order created in the order creation step S21, the tablet inspecting unit 16 selects the tablet pattern D having the smallest area from the tablet patterns having the inspection code of “not processed” as the tablet pattern for the pattern matching. Using the tablet pattern D, the tablet inspecting unit 16 performs the pattern matching within the medicine pack image for search 33d in FIG. 10. In the matching step S22, the tablet inspecting unit 16 determines two black regions having a pattern matched with the tablet pattern D as the tablet regions 51a and 52a, counts the number of tablet regions 51a and 52a having the tablet pattern D, and obtains information that the number of tablet regions 51a and 52a having the tablet pattern D is 2. In the tablet region deletion step S23, the tablet inspecting unit 16 deletes the tablet regions 51a and 52a having the tablet pattern D, which are determined in the matching step S22, from the medicine pack image for search 33d, and produces a new medicine pack image for search. In the tablet number inspection step S24, the tablet inspecting unit 16 compares the number of tablet regions having the tablet pattern D with the number of tablet patterns D in the packing pattern information 27, wherein the number of tablet regions having the tablet pattern D is 2 and the number of tablet patterns D is 2. Here, the number of tablet regions having the tablet pattern D is equal to the number of tablet patterns D. Accordingly, the tablet inspecting unit 16 changes the inspection code of the tablet pattern D from “not processed” to “processed.” Then, the processing goes to the progress check step S25. In the progress check step S25, it is determined that no tablet pattern having the inspection code of “not processed” exists, and the processing goes to Step S05.

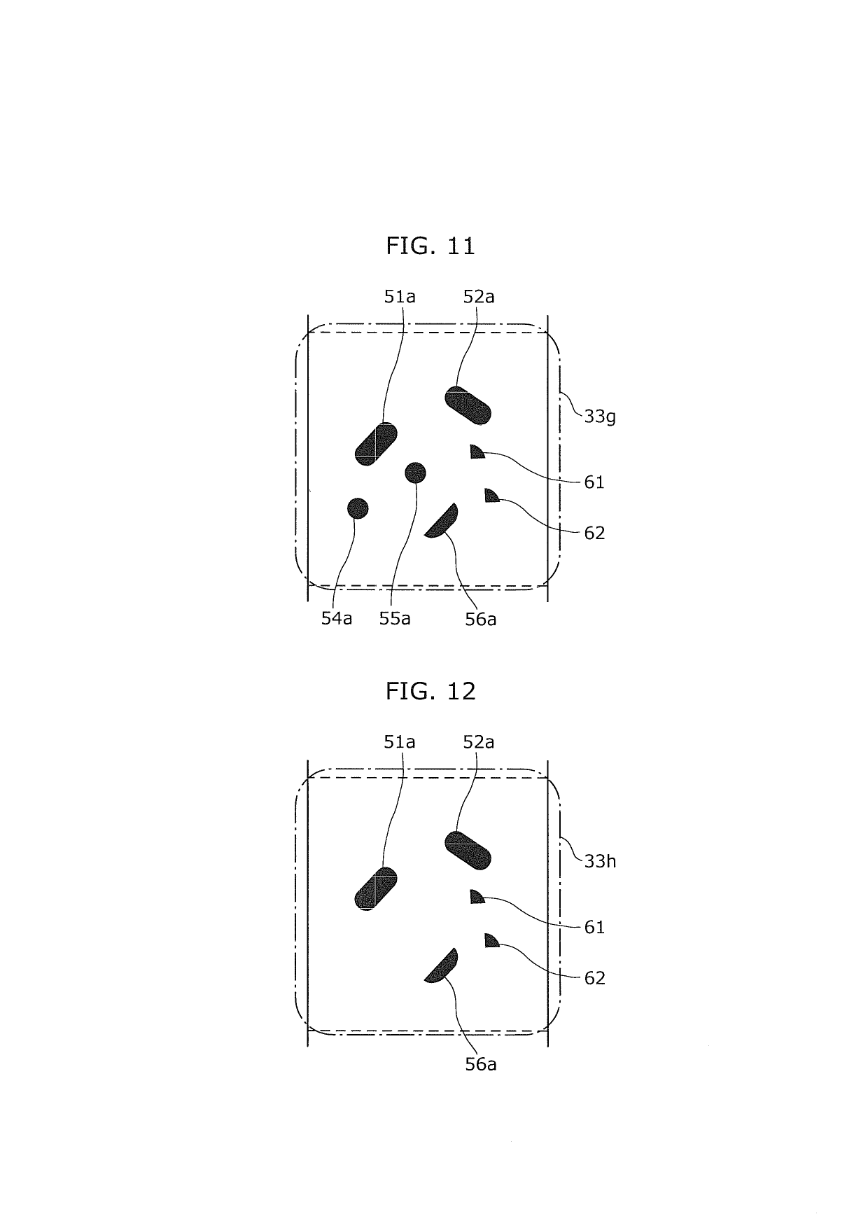

Next, operation to detect a broken tablet including Steps S26 to S28 will be described with reference to FIG. 11 and FIG. 12.

FIG. 11 is a drawing showing an example of a medicine pack image 33g in which the irregular shaped tablet B is broken. Within the medicine pack image 33g, two tablet regions 51a and 52a corresponding to the regular shaped tablet A, two tablet regions 54a and 55a corresponding to the regular shaped tablet C, one irregular shaped tablet region 56a corresponding to the irregular shaped tablet D, and candidates for the broken tablet regions 61 and 62 corresponding to the irregular shaped tablet B exist.

First, by the operation in Step S21, the order of the tablet patterns for pattern matching is decided. By the operation from Steps S22 to S25, using the tablet pattern C having the smallest area of the tablet pattern, the pattern matching is performed within the medicine pack image 33g in FIG. 11, and the tablet regions 54a and 55a having a pattern matched are determined. Then, the tablet regions 54a and 55a having the pattern matched with the tablet pattern C are deleted, and a new medicine pack image for search 33h is produced. The medicine pack image for search 33h is shown in FIG. 12. The number of tablet regions having the tablet pattern C is equal to the number of tablet patterns C in the packing pattern information 27. Accordingly, the inspection code of the tablet pattern C is changed to “processed.” In the progress check step S25, it is determined that the tablet pattern having the inspection code of “not processed” exists, and the processing goes to the matching step S22

In the second matching step S22, using the tablet pattern Bha having the second smallest area of the tablet pattern, the tablet inspecting unit 16 performs the pattern matching within the medicine pack image for search 33h in FIG. 12. However, no tablet region having a pattern matched with the tablet pattern Bha exists within the medicine pack image for search 33h, and the number of tablet patterns Bha is 0. In the tablet region deletion step S23, the tablet inspecting unit 16 deletes the tablet region detected in the medicine pack image for search 33h, and produces a new medicine pack image for search. Here, however, no tablet region is detected. Accordingly, the medicine pack image for search is the same as the medicine pack image 33h in FIG. 12. Here, the number of tablet regions having the tablet pattern Bha is not equal to the number of tablets pattern Bha in the packing pattern information 27 (the number of tablet regions having the tablet pattern Bha is short) wherein the number of tablet regions having the tablet pattern Bha is 0 and the number of tablet patterns Bha is 1. Then, after the tablet number inspection step S24, the processing goes to the breakage detection step S26.

In the breakage detection step S26, using the area of the selected tablet pattern Bha as the reference area, the tablet inspecting unit 16 detects a black region having an area smaller than the reference area within the medicine pack image for search 33h as the candidate for a broken tablet region. Thereby, the tablet inspecting unit 16 searches for several candidates for the broken tablet region. An example of the candidates for the broken tablet regions 61 and 62 is shown in FIG. 12. The tablet inspecting unit 16 determines the area of each of the candidates for the broken tablet regions 61 and 62, and sums up these areas to determine the total area. The tablet inspecting unit 16 compares the total area with the reference area of the tablet pattern Bha, and determines whether the total area is equal (or approximately equal) to the reference area. Here, because the total area falls within 90 to 110% of the reference area, the tablet inspecting unit 16 determines that the total area is equal to the reference area. Thereby, it is determined that the candidates for the broken tablet regions 61 and 62 correspond to the broken tablet region having the tablet pattern Bha. The total area of the candidates for the broken tablet regions 61 and 62 is equal to the reference area of one tablet pattern Bha. Accordingly, the number of tablet regions having the tablet pattern Bha is 1. The tablet inspecting unit 16 may check whether a synthesized shape matches with the tablet pattern Bha by synthesizing the shapes of the candidates for the broken tablet regions 61 and 62 used for summing up, and performing the pattern matching between the synthesized shape and the tablet pattern Bha. Usually, one irregular shaped tablet of the same kind is enclosed in the medicine pack 13. When the irregular shaped tablet is broken, the irregular shaped tablet can be counted according to the method above. The same method can be repeated and the number of irregular shaped tablets can be counted even when two irregular shaped tablets having the tablet pattern of the same irregular shaped tablet are broken.

In the broken tablet region deletion step S27, the tablet inspecting unit 16 deletes the candidates for the broken tablet regions 61 and 62 determined as the tablet pattern Bha in the breakage detection step S26 from the medicine pack image for search 33h, and produces a new medicine pack image for search. The new medicine pack image for search is used for the subsequent pattern matching of the tablet pattern.

In the broken tablet number inspection step S28, the tablet inspecting unit 16 compares the number of tablet regions having the tablet pattern Bha, which are counted in the breakage detection step S26 (here, 1), with the number of missing tablets calculated in the tablet number inspection step S24 (here, 1). Here, the number of tablet regions having the tablet pattern Bha is equal to the number of missing tablets. Accordingly, the tablet inspecting unit 16 changes the inspection code of the tablet pattern Bha from “not processed” to “processed.” Then, the processing goes to the progress check step S25.

In the progress check step S25, it is determined that the tablet pattern having the inspection code of “not processed” exists, and the processing goes to the matching step S22. The operation after that is the same as that already described.

The medicine pack inspecting system 10 according to Embodiment 1 has a particularly significant effect of inspection when the tablet dividing unit 14 has the tablet dividing function. When the tablet dividing unit 14 has the tablet dividing function, the tablet dividing unit 14 divides the regular shaped tablet B in half mechanically based on the packing instruction information 26 in the packing instruction unit 11, and produces the irregular shaped tablet B. The tablet packing unit 12 encloses the produced irregular shaped tablet B mechanically. Although this is a very rare case, the tablet dividing unit 14 may fail in division of the regular shaped tablet B, and the regular shaped tablet B may be enclosed in the medicine pack 13 instead of the irregular shaped tablet B. In such a case, an error concerning the difference in the shape cannot be detected only by counting the number of tablet regions within the medicine pack image. In the medicine pack inspecting system 10 according to Embodiment 1, inspection including the shape of the irregular shaped tablet is performed. For this reason, when the regular shaped tablet B instead of the irregular shaped tablet B is enclosed in the medicine pack 13, the inconsistency in the shape can be detected. When the inconsistency in the shape is detected, for example, the medicine pack inspecting system 10 stops the inspection, and displays an alarm on the display unit 18.

Moreover, in the medicine pack inspecting system 10 according to Embodiment 1, the tablet inspecting unit 16 obtains the pattern of the regular shaped tablet included in the packing instruction information 26 from the tablet information holding unit 20, and divides the pattern of the regular shaped tablet by the number of divisions included in the packing instruction information 26 to generate the irregular shaped tablet pattern. For example, based on the packing instruction information 26, the tablet inspecting unit 16 divides the pattern of the regular shaped tablet B in half in the direction a to produce the irregular shaped tablet pattern Bha. For this reason, the tablet information holding unit 20 may hold patterns of the regular shaped tablets in a variety of tablets. This facilitates creation of a database. Moreover, based on the number of divisions and the direction of division included in the packing instruction information 26, the tablet inspecting unit 16 divides the pattern of the regular shaped tablet to generate the irregular shaped tablet pattern. For this reason, the irregular shaped tablet pattern having an accurate shape can be generated, increasing accuracy of the pattern matching of the irregular shaped tablet. When the direction of division is not specified in the packing instruction information 26, the tablet inspecting unit 16 may produce the irregular shaped tablet pattern Bha obtained by dividing the pattern of the regular shaped tablet B in half in the direction a and the irregular shaped tablet pattern Bhb obtained by dividing the pattern of the regular shaped tablet B in half in the direction b, and detect the tablet region having a pattern matched with the irregular shaped tablet pattern Bha and the tablet region having a pattern matched with the irregular shaped tablet pattern Bhb.

In the medicine pack inspecting system 10 according to Embodiment 1, first, the tablet inspecting unit 16 determines the tablet region having a pattern matched with the irregular shaped tablet pattern within the medicine pack image for search. Then, every time when the tablet inspecting unit 16 determines the tablet region having a pattern matched with the irregular shaped tablet pattern, the tablet region having a pattern matched with the irregular shaped tablet pattern deletes the determined tablet region from the medicine pack image for search, and generates a new medicine pack image for search. Then, using the new medicine pack image for search, the tablet inspecting unit 16 detects the tablet region having a pattern matched with the next the irregular shaped tablet pattern. Thereby, the candidates for the tablet region within the medicine pack image for search are decreased every time when pattern matching of the irregular shaped tablet is performed. For this reason, errors in the pattern matching are decreased, and the time for the pattern matching is shortened. Such effects are also obtained in the case of the pattern matching of the regular shaped tablet.

Moreover, in packing the tablets in the medicine pack, the tablet packing unit 12 causes the tablet dividing unit 14 to divide the regular shaped tablet and produce the irregular shaped tablet, and gravitationally drops the divided irregular shaped tablet and other regular shaped tablets together into the medicine pack. The tablet packing unit 12 collectively encloses several tablets of several kinds to be taken at one time by the patient in the medicine pack, and seals the medicine pack mechanically. The irregular shaped tablet is produced by mechanically dividing the regular shaped tablet in half or quarters, and much more fragile than the regular shaped tablet. For this reason, the irregular shaped tablet enclosed in the medicine pack is often broken. When the broken irregular shaped tablet is enclosed in the medicine pack, the number of black regions within the medicine pack image is larger than that when no broken irregular shaped tablet is enclosed in the medicine pack. As a result, the number of tablets in the medicine pack cannot be accurately obtained according to the method for counting the number of black regions within the medicine pack image.

For this reason, in the medicine pack inspecting system according to Embodiment 1, when the number of tablet regions having a pattern matched with the irregular shaped tablet pattern and detected within the medicine pack image for search is smaller than the number of irregular shaped tablet patterns shown in the packing pattern information, the tablet inspecting unit 16 detects the candidate for a broken tablet region having a region area smaller than the area of the tablet the irregular shaped tablet pattern within the medicine pack image for search. Moreover, the tablet inspecting unit 16 determines whether the total area obtained by summing up the region areas of the candidates for the broken tablet region (the areas of several regions are added) is equal to the area of the tablet the irregular shaped tablet pattern. When the synthesized area of the several candidates for the broken tablet region is approximately equal to the area of the tablet the irregular shaped tablet pattern, the tablet inspecting unit 16 detects the region obtained by synthesizing the several candidates for the broken tablet region as the tablet region having a pattern matched with the irregular shaped tablet pattern. Thereby, the tablet inspecting unit 16 can accurately inspect the tablets including the shape of the irregular shaped tablet even if the irregular shaped tablet is broken. The same accurate inspection can also be performed when the regular shaped tablet is broken, although this is a very rare case.

In the medicine pack inspecting system 10 according to Embodiment 1, the tablet inspecting unit 16 performs the pattern matching of the tablet patterns in the ascending order of areas of the tablet pattern. For this reason, errors in the pattern matching of the tablet patterns are reduced, enabling accurate inspection. This will be described. For example, suppose the case where the pattern matching is performed in a descending order of areas of the tablet pattern, that is, from the regular shaped tablet A. The tablet pattern of the regular shaped tablet A has the area larger than the areas of the tablet patterns of other tablets. When the other tablets are densely packed in the medicine pack 13, the densely packed block may be considered as one tablet region and subjected to the pattern matching. For this reason, an error is easily caused in the result of inspection when the other tablets are densely packed in the medicine pack 13. Thus, an error may be caused in the result of inspection when the pattern matching is performed in a descending order of areas of the tablet pattern in the manner opposite to that in the present embodiment.

Moreover, in the medicine pack inspecting system 10 according to Embodiment 1, the tablet inspecting unit 16 performs the pattern matching in the ascending order of areas of the tablet pattern. For this reason, when the target tablet is broken, the number of candidates for the broken tablet region can be reduced, and the broken tablet region can be accurately selected in a short time. This will be described. For example, suppose that the pattern matching is performed from the regular shaped tablet A in the ascending order of areas of the tablet pattern, and one of two regular shaped tablets A is broken. In this case, using the tablet pattern A, one tablet region corresponding to a normal regular shaped tablet A can be detected. However, the broken regular shaped tablet A cannot be detected as it is, and the candidate for a broken tablet region needs to be searched. At this time, because the area of the tablet pattern A is the largest, all the tablet regions corresponding to the irregular shaped tablet B, the regular shaped tablet C, and the irregular shaped tablet D are the candidates for the broken tablet region for the regular shaped tablet A. As a result, the number of candidates for the broken tablet region is increased, the time for narrowing processing is longer, and an error in selection is more easily caused. Thus, an error in selection may be caused when the pattern matching is performed in a descending order of areas of the tablet pattern in the manner opposite to that in the present embodiment.

Further, in the medicine pack inspecting system 10 according to Embodiment 1, the tablet inspecting unit 16 repeatedly performs the following (a) and (b) in the ascending order of areas of the tablet pattern.

(a) The number of the tablets corresponding to the tablet pattern is counted by detecting the tablet region having a pattern matched with the tablet pattern within the medicine pack image for search.
(b) The new medicine pack image for search is generated by deleting the detected tablet region from the medicine pack image for search.

By performing (a) and (b), the candidates for the tablet region within the medicine pack image for search are decreased every time when the pattern matching of the tablet pattern is performed. As a result, errors are reduced during the pattern matching, and the time for the pattern matching is shortened.

In the medicine pack inspecting system 10 according to Embodiment 1, the packing instruction unit 11 outputs the sheet of the packing instruction information in which the packing instruction information 26 is written in the two-dimensional bar code. The tablet inspecting unit 16 reads the two-dimensional code printed on the sheet of the packing instruction information using the attached code input unit 21, and obtains the packing instruction information 26. The reading of the packing instruction information 26 is not limited to this. Alternatively, the packing instruction unit 11 may record the packing instruction information 26 in an electronic recording medium such as a Radio Frequency IDentification (RFID), the information recorded in the RFID using a code input unit having an RFID reading function, and input the packing instruction information to the tablet inspecting unit 16. Alternatively, electronic data of the packing instruction information may be directly transmitted to the tablet inspecting unit 16 from the packing instruction unit 11 via an intranet line whose security is ensured.

Moreover, the tablet inspecting unit 16 may sequentially display the medicine pack image for search or the result of inspection of the medicine pack on the display unit 18.

Moreover, for example, when the prescription information 25 indicates the number of tablets B of 1.5, the tablet inspecting unit 16 produces two tablet patterns of the tablet pattern B and the tablet pattern Bha as the packing pattern information 27, and produces the area of the tablet pattern B and the area of the tablet pattern Bha. The tablet pattern B and the tablet pattern Bha are different tablet patterns. The tablet inspecting unit 16 performs the pattern matching on the tablet pattern B and the tablet pattern Bha individually. Thus, the medicine pack inspecting system according to Embodiment 1 performs the pattern matching on the irregular shaped tablet B and the regular shaped tablet B using the different tablet patterns even if the kind of the tablet is the same tablet B. As a result, the medicine pack inspecting system according to Embodiment 1 enables accurate inspection of the tablets including the shape of the irregular shaped tablet B.

### Embodiment 2

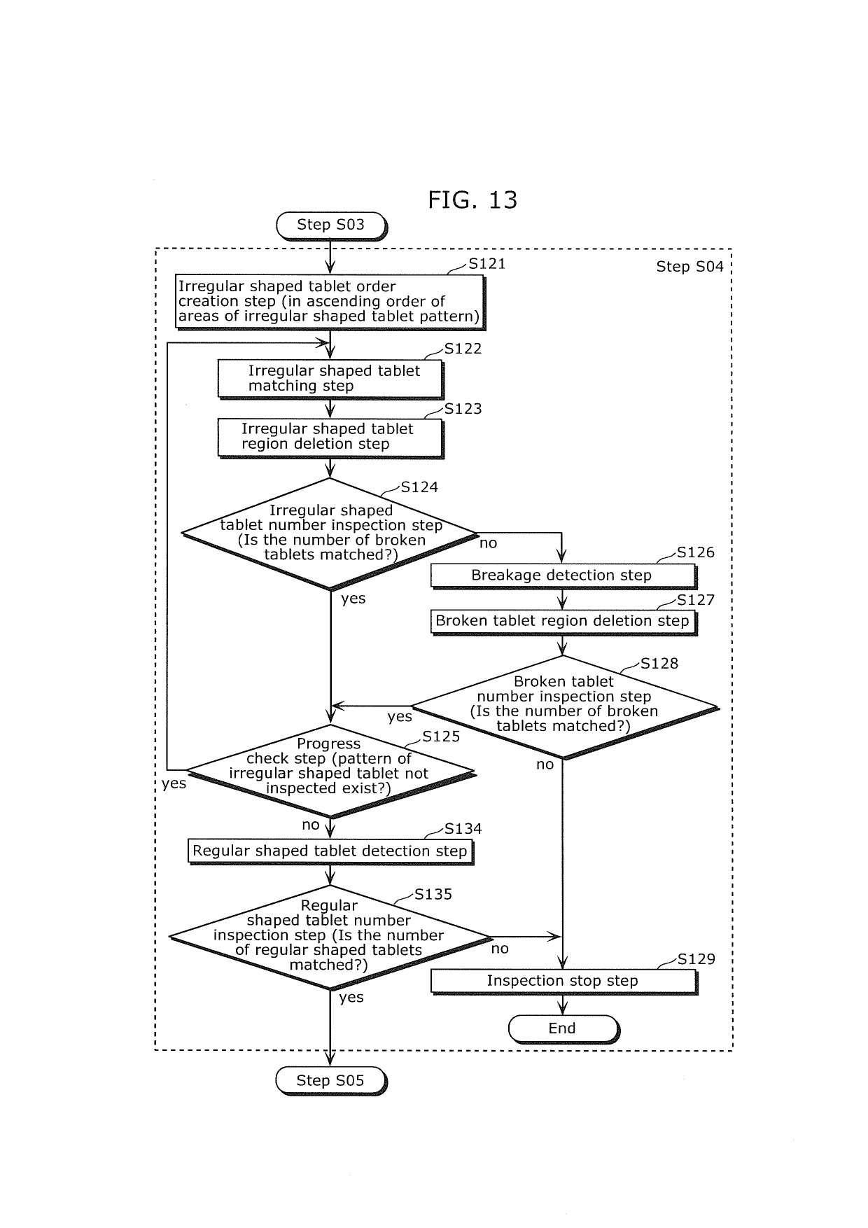

In Embodiment 2 of the present invention, the inspection step S04 shown in FIG. 3 is described in a flowchart shown in FIG. 13 instead of the flowchart shown in FIG. 4. Other configuration is the same as that in Embodiment 1, and the description will be omitted. Hereinafter, differences between Embodiment 2 and Embodiment 1 will be described with reference to the drawings.

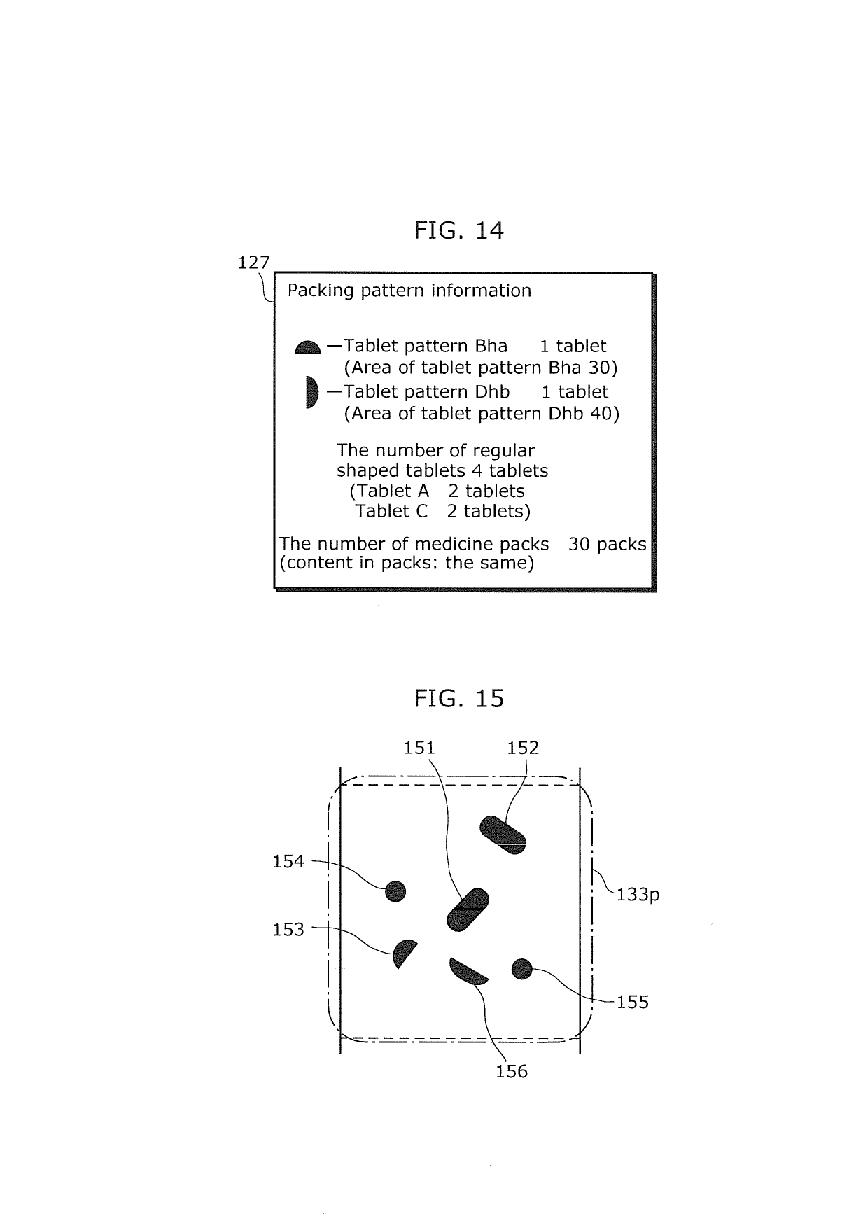

FIG. 13 is the flowchart showing the detailed steps of the inspection step S04 according to Embodiment 2 of the present invention. FIG. 14 is a drawing showing packing pattern information 127 according to Embodiment 2.

Based on the packing instruction information 26 shown in FIG. 2B and obtained from the packing instruction unit 11, the tablet inspecting unit 16 produces the packing pattern information 127 shown in FIG. 14. Namely, based on the irregular shaped tablet B in the packing instruction information 26, the tablet inspecting unit 16 reads the tablet pattern B and the value of 60 mm² indicating the area of the tablet pattern B from the tablet information holding unit 20, produces the tablet pattern Bha of the irregular shaped tablet B (divided in half, in the direction a), and obtains the value of 30 mm² as the area of the tablet pattern Bha. Then, the tablet inspecting unit 16 sets the tablet pattern Bha, the number of tablets at 1, and the value of the area of the tablet pattern Bha at 30 mm² in the packing pattern information 127. Here, the tablet pattern Bha of the irregular shaped tablet B is produced by dividing the tablet pattern B of the regular shaped tablet B in half in the direction a, and the area of the tablet pattern Bha is obtained by multiplying the area of the tablet pattern B by ½. Similarly, based on the irregular shaped tablet D from the packing instruction information 26, the tablet inspecting unit 16 reads the tablet pattern D and the value of mm² as the area of the tablet pattern D from the tablet information holding unit 20, produces the tablet pattern Dhb of the irregular shaped tablet D (divided in half, in the direction b), and obtains the value of 40 mm² as the area of the tablet pattern Dhb. Then, the tablet inspecting unit 16 sets the tablet pattern Dhb, the number of tablets at 1, and the value of the area of the tablet pattern Dhb at 40 mm² in the packing pattern information 127. Here, the tablet pattern Dhb of the irregular shaped tablet D is produced by dividing the tablet pattern D of the regular shaped tablet D in half in the direction b, and the area of the tablet pattern Dhb is obtained by multiplying the area of the tablet pattern D by ½. Moreover, based on the regular shaped tablet A and regular shaped tablet C in the packing instruction information 26, the tablet inspecting unit 16 produces the information indicating the number of regular shaped tablets of 4 (two regular shaped tablets A, two regular shaped tablets C) in the packing pattern information 127. Further, the packing instruction information 26 indicates that the number of days is for 10 days, and the tablets are to be taken 3 times a day (the same content is to be taken at morning, noon, and night). Based on the packing instruction information 26, the tablet inspecting unit 16 sets the number of medicine packs at 30 and the same tablets for each of the medicine packs in the packing pattern information 127.

Next, the operation of the inspection step will be specifically described with reference to the flowchart shown in FIG. 13.

First, an irregular shaped tablet order creation step S121 in FIG. 13 will be described.

In the irregular shaped tablet order creation step S121, the tablet inspecting unit 16 compares the areas of the irregular shaped tablet patterns of the irregular shaped tablets included in the packing pattern information 127 (hereinafter, referred to as an “area of the irregular shaped tablet pattern”), and the order of the tablet patterns is created in an ascending order of areas of the irregular shaped tablet pattern. The tablet inspecting unit 16 assigns inspection codes to the respective tablet patterns, and sets all the inspection codes at “not processed.” For example, in the packing pattern information 127 shown in FIG. 14, the tablet inspecting unit 16 produces the tablet pattern Bha as the first tablet pattern, and the tablet pattern Dhb as the second tablet pattern in an ascending order of areas of the irregular shaped tablet pattern, and sets the inspection code of the tablet pattern Bha and that of the tablet pattern Dhb at “not processed.” According to the order of the tablet patterns created here, the tablet inspecting unit 16 sequentially performs the pattern matching in Steps S122 to S128 operated in a loop.

Subsequently, an irregular shaped tablet matching step S122 shown in FIG. 13 will be described.

In the irregular shaped tablet matching step S122, referring to the order of the irregular shaped tablets produced in the order creation step S121, the tablet inspecting unit 16 selects the irregular shaped tablet pattern having the smallest area from the irregular shaped tablet patterns of the irregular shaped tablets (hereinafter, referred to as the “the irregular shaped tablet pattern”) having the inspection code of “not processed.” Thereby, the tablet inspecting unit 16 selects the irregular shaped tablet pattern for the pattern matching. The tablet inspecting unit 16 searches for the image region having a pattern matched with the irregular shaped tablet pattern within the medicine pack image for search, and determines the image region as the irregular shaped tablet region having the irregular shaped tablet pattern. Here, when the patterns of several image regions are matched, the tablet inspecting unit 16 determines the patterns as the irregular shaped tablet region. In Embodiment 2, only the irregular shaped tablet pattern is selected as the tablet pattern for the pattern matching. For this reason, the tablet inspecting unit 16 can count the number of irregular shaped tablet regions having the irregular shaped tablet pattern.

Subsequently, an irregular shaped tablet region deletion step S123 shown in FIG. 13 will be described.

In the irregular shaped tablet region deletion step S123, the tablet inspecting unit 16 deletes the irregular shaped tablet region determined in the irregular shaped tablet matching step S122 from the medicine pack image for search, and produces a new medicine pack image for search. The new medicine pack image for search is used for the subsequent pattern matching of the irregular shaped tablet pattern.

Subsequently, an irregular shaped tablet number inspection step S124 shown in FIG. 13 will be described.

In the irregular shaped tablet number inspection step S124, the tablet inspecting unit 16 compares the number of irregular shaped tablet regions counted in the irregular shaped tablet matching step S122 with the number of irregular shaped tablet patterns for the pattern matching shown in the packing pattern information 127. When the number of irregular shaped tablet regions is equal to the number of irregular shaped tablet patterns for the pattern matching (yes in Step S124), the tablet inspecting unit 16 changes the inspection code of the irregular shaped tablet pattern to “processed.” Then, the processing goes to a progress check step S125. When the number of irregular shaped tablet regions is not equal to the number of irregular shaped tablet patterns for the pattern matching (no in Step S124), namely, when the number of irregular shaped tablet regions is smaller than the number of irregular shaped tablet patterns, the tablet inspecting unit 16 counts the number of missing tablets, and the processing goes to a breakage detection step S126.

Subsequently, the progress check step S125 shown in FIG. 13 will be described.

In the progress check step S125, the tablet inspecting unit 16 checks whether the irregular shaped tablet pattern not inspected exists or not. When it is determined that the irregular shaped tablet pattern having the inspection code of “not processed” exists (yes in Step S125), the processing goes to the irregular shaped tablet matching step S122 in the loop. When it is determined that no the irregular shaped tablet pattern having the inspection code of “not processed” exists (no in Step S25), the inspection of all the irregular shaped tablet patterns within the medicine pack 13 is completed. Then, the processing goes to a regular shaped tablet detection step S134.

Subsequently, the breakage detection step S126 shown in FIG. 13 will be described.

In the breakage detection step S126, the tablet inspecting unit 16 uses the area of the selected irregular shaped tablet pattern as a reference area, detects a pixel region having an area smaller than the reference area within the medicine pack image for search as the candidate for a broken tablet region, and searches for several candidates for the broken tablet region. A predetermined conversion ratio between the areas units of the irregular shaped tablet pattern and area units of the pixel region within the medicine pack image is set. Here, description is given at a conversion ratio of 1. The tablet inspecting unit 16 determines the areas of the candidates for the broken tablet region. The tablet inspecting unit 16 arbitrarily chooses two or more candidates from the several candidates for the broken tablet region, and sums up the areas of the chosen two or more candidates for the broken tablet region. When the total area is equal or approximately equal to the reference area of the selected the irregular shaped tablet pattern, the tablet inspecting unit 16 determines the two or more candidates for the broken tablet region used for summing up as two or more broken tablet regions for the irregular shaped tablet pattern, and counts the determined two or more broken tablet regions as one irregular shaped tablet region having the irregular shaped tablet pattern. When no candidate for a broken tablet region exists, the number of irregular shaped tablet regions having the irregular shaped tablet pattern is 0. The irregular shaped tablet region can be found by synthesizing the two or more candidates for the broken tablet region used for summing up, and performing the pattern matching between the synthesized shape and the selected the irregular shaped tablet pattern. Moreover, when the number of missing tablets calculated in the tablet number inspection step S24 is 2, the tablet inspecting unit 16 can determine the second irregular shaped tablet region having the irregular shaped tablet pattern by selecting another two or more candidates for the broken tablet region from the several candidates for the broken tablet region, and performing the pattern matching using the total area or the synthesized shape.

Subsequently, a broken tablet region deletion step S127 shown in FIG. 13 will be described.

In the broken tablet region deletion step S127, the tablet inspecting unit 16 deletes the broken tablet region determined in the breakage detection step S126 from the medicine pack image for search, and produces a new medicine pack image for search. The new medicine pack image for search is used for the subsequent pattern matching of the irregular shaped tablet pattern.

Subsequently, a broken tablet number inspection step S128 shown in FIG. 13 will be described.

In the broken tablet number inspection step S128, the tablet inspecting unit 16 compares the number of irregular shaped tablet regions counted in the breakage detection step S126 with the number of missing tablets calculated in the irregular shaped tablet number inspection step S124. When the number of irregular shaped tablet regions is equal to the number of missing tablets (yes in Step S128), the tablet inspecting unit 16 changes the inspection code of the irregular shaped tablet pattern to “processed.” Then, the processing goes to a progress check step S125. When the number of irregular shaped tablet regions is not equal to the number of missing tablets (no in Step S128), the processing goes to an inspection stop step S129.

Subsequently, an inspection stop step S129 shown in FIG. 13 will be described.

In the inspection stop step S129, the tablet inspecting unit 16 stops the inspection operation of the medicine pack 13, and displays an alarm on the display unit 18, for example.

Subsequently, a regular shaped tablet detection step S134 shown in FIG. 13 will be described.

The regular shaped tablet detection step S134 is executed after the matching of the shape and the number in all the irregular shaped tablet patterns in Steps S122 to S128 is completed. In the regular shaped tablet detection step S134, using the medicine pack image for search after the irregular shaped tablet regions having the irregular shaped tablet pattern are all deleted, the tablet inspecting unit 16 detects the tablet region within the medicine pack image for search, and counts the number of tablet regions.

A variety of known methods can be used as a method for detecting the number of tablet regions used in the regular shaped tablet detection step S134. For example, the following methods can be used: a method of determining the number of tablets by using the medicine pack image for search and counting the number of black regions within the medicine pack image, or a method of determining the number of tablets by performing erosion, dilation, and labeling on the black region within the medicine pack image to separate and extract the tablet region, and counting the number of the separated regions. An alternative method can be used: a corner is extracted in the black region within the medicine pack image for search, the number of the extracted corners and the number of the black regions are determined, and the number of tablets is calculated. Alternatively, the number of tablets may be determined by inverting black and white of the medicine pack image and counting the number of white regions.

Subsequently, a regular shaped tablet number inspection step S135 shown in FIG. 13 will be described.

In the regular shaped tablet number inspection step S135, the tablet inspecting unit 16 checks whether the number of tablet regions counted in the regular shaped tablet detection step S134 is equal to the number of regular shaped tablets shown in the packing pattern information 127. When the number of tablet regions is equal to the number of regular shaped tablets (yes in Step S135), the tablet inspecting unit 16 determines that the regular shaped tablet is normally inspected. The processing goes to Step S05 because the inspection of the tablets in the entire medicine pack 13 is completed. When the number of tablet regions is not equal to the number of regular shaped tablets (no in Step S135), the processing goes to the inspection stop step S129.

Operation from Steps S122 to S125 will be described with reference to FIG. 15 to FIG. 17. FIG. 15 is a drawing showing an example of a first medicine pack image for search 133p obtained from the image captured by the image capturing unit 15. Within the medicine pack image 133p, two tablet regions 151 and 152 corresponding to the regular shaped tablet A, one irregular shaped tablet region 153 corresponding to the irregular shaped tablet B, two tablet regions 154 and 155 corresponding to the regular shaped tablet C, and an irregular shaped tablet region 156 corresponding to the irregular shaped tablet D exist.

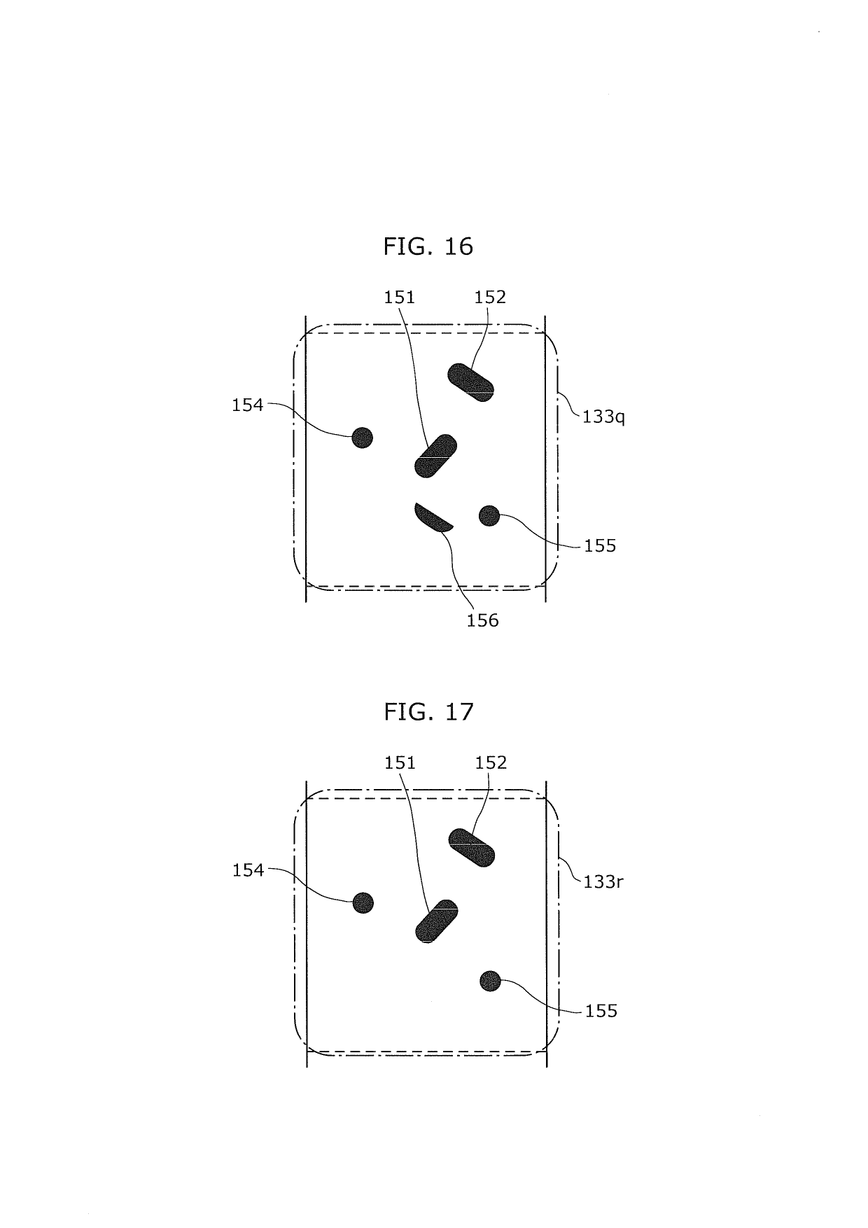

First, in the irregular shaped tablet matching step S122, referring to the order created in the order creation step S121, the tablet inspecting unit 16 extracts the irregular shaped tablet pattern Bha having the smallest area from the irregular shaped tablet patterns having the inspection code of “not processed” as the irregular shaped tablet pattern for the pattern matching. Using the irregular shaped tablet pattern Bha, the tablet inspecting unit 16 performs the pattern matching within the medicine pack image for search 133p in FIG. 15. In the irregular shaped tablet matching step S122, the tablet inspecting unit 16 determines one black region having a pattern matched with the irregular shaped tablet pattern Bha as the irregular shaped tablet region 153, counts the number of irregular shaped tablet regions 153 having the irregular shaped tablet pattern Bha, and obtains information that the number of irregular shaped tablet regions 153 is 1. In the irregular shaped tablet region deletion step S123, the tablet inspecting unit 16 deletes the irregular shaped tablet region 153 having the irregular shaped tablet pattern Bha, which is determined in the irregular shaped tablet matching step S122, from the medicine pack image for search 133p, and produces a new medicine pack image for search 133q. The medicine pack image for search 133q is shown in FIG. 16. In the irregular shaped tablet number inspection step S124, the tablet inspecting unit 16 compares the number of irregular shaped tablet regions having the irregular shaped tablet pattern Bha with the number of irregular shaped tablet patterns Bha in the packing pattern information 127, wherein the number of the irregular shaped tablet regions is 1 and the number of irregular shaped tablet patterns Bha is 1. Here, the number of irregular shaped tablet regions having the irregular shaped tablet pattern Bha is equal to the number of irregular shaped tablet patterns Bha. Accordingly, the tablet inspecting unit 16 changes the inspection code of the irregular shaped tablet pattern Bha from “not processed” to “processed,” and the processing goes to the progress check step S125. In the progress check step S125, because the irregular shaped tablet pattern having the inspection code of “not processed” exists, the processing goes to the irregular shaped tablet matching step S122.

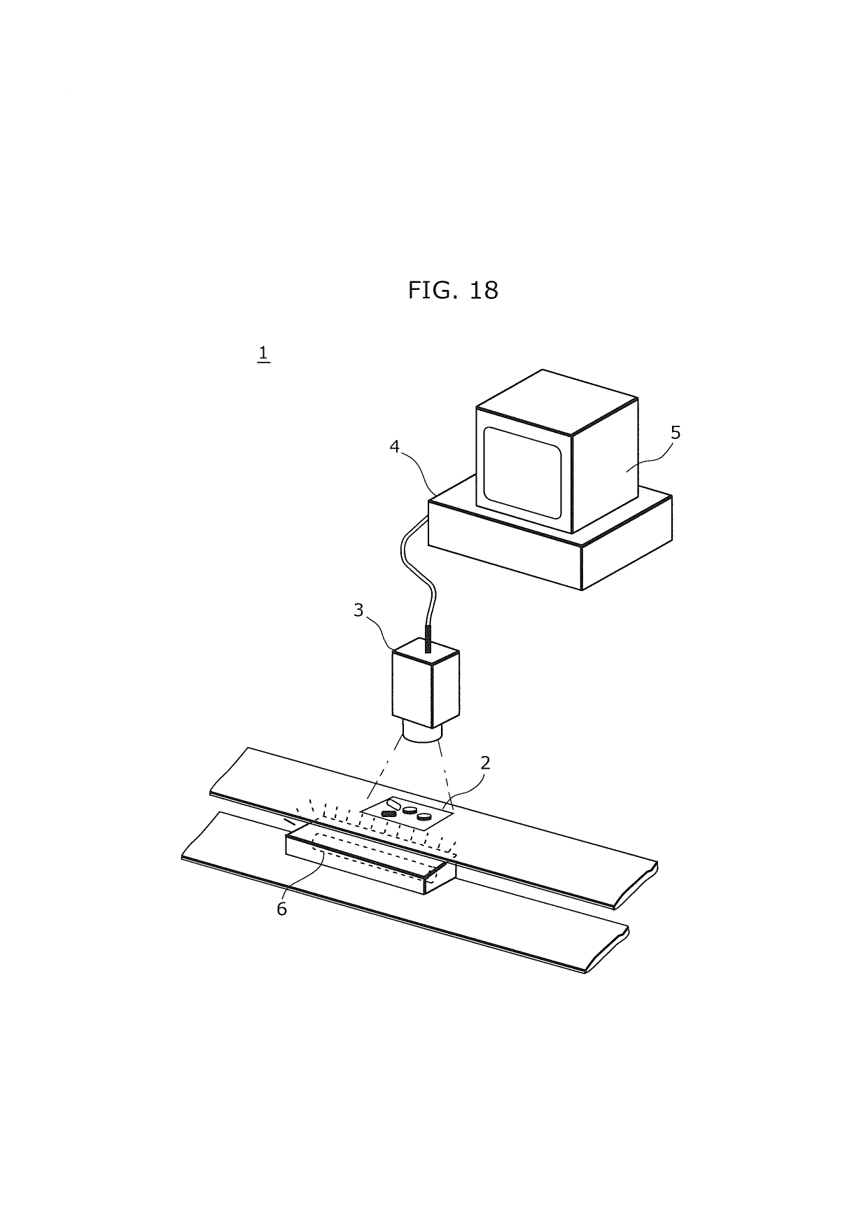

In the second irregular shaped tablet matching step S122, referring to the order created in the order creation step S121, the tablet inspecting unit 16 extracts the irregular shaped tablet pattern Dhb having the smallest area from the irregular shaped tablet pattern having the inspection code of “not processed” as the irregular shaped tablet pattern for the pattern matching. Using the irregular shaped tablet pattern Dhb, the tablet inspecting unit 16 performs pattern matching inspection within the medicine pack image for search 133q in FIG. 16. In the irregular shaped tablet matching step S122, the tablet inspecting unit 16 determines one black region having a pattern matched with the irregular shaped tablet pattern Dhb as the irregular shaped tablet region 156, counts the number of irregular shaped tablet regions 156 having the irregular shaped tablet pattern Dhb, and obtains the number of irregular shaped tablet regions of 1. In the irregular shaped tablet region deletion step S123, the tablet inspecting unit 16 deletes the irregular shaped tablet region 156 having the irregular shaped tablet pattern Dhb, which is determined in the irregular shaped tablet matching step S122, from the medicine pack image for search 133q, and produces a new medicine pack image for search 133r. The medicine pack image for search 133r is shown in FIG. 17. In the irregular shaped tablet number inspection step S124, the tablet inspecting unit 16 compares the number of irregular shaped tablet regions having the irregular shaped tablet pattern Dhb with the number of irregular shaped tablet patterns Dhb in the packing pattern information 127, wherein the number of the irregular shaped tablet regions is 1 and the number of irregular shaped tablet patterns Dhb is 1. Here, the number of irregular shaped tablet regions having the irregular shaped tablet pattern Dhb is equal to the number of irregular shaped tablet patterns Dhb. Accordingly, the tablet inspecting unit 16 changes the inspection code of the irregular shaped tablet pattern Dhb from “not processed” to “processed,” and the processing goes to the progress check step S125. In the progress check step S125, because no the irregular shaped tablet pattern having the inspection code of “not processed” exists, the tablet inspecting unit 16 determines that all the irregular shaped tablets in the medicine pack 13 are normally inspected. Then, the processing goes to the regular shaped tablet detection step S134.

When the irregular shaped tablet is broken, the operation in the breakage detection step S126 is the same as that in the breakage detection step S26, the operation in the broken tablet region deletion step S127 is the same as that in the broken tablet region deletion step S27, and the operation in the broken tablet number inspection step S128 is the same as that in broken tablet number inspection step S28. Accordingly, the entire operation from Steps S126 to S128 is the same as that from Steps S26 to S28, and the effect of Steps S126 to S128 is the same as that of Steps S26 to S28. The detailed description will be omitted.

Next, the operation in the regular shaped tablet detection step S134 and the operation in the regular shaped tablet number inspection step S135 will be described. The regular shaped tablet detection step S134 is executed after all the irregular shaped tablet patterns are inspected and checked from Steps S122 to S128. For this reason, as shown in FIG. 17, the irregular shaped tablet region having the irregular shaped tablet pattern Bha and the irregular shaped tablet region having the irregular shaped tablet pattern Dhb are removed, and only the tablet regions corresponding to the regular shaped tablets remain in the medicine pack image for search 133r used in the regular shaped tablet detection step S134. In the regular shaped tablet detection step S134, the tablet inspecting unit 16 detects the tablet region within the medicine pack image for search 133r, and counts the number of tablet regions. The obtained number is 4. In the regular shaped tablet number inspection step S135, the tablet inspecting unit 16 compares the result of counting in the regular shaped tablet detection step S134, which is 4, with the number of regular shaped tablets in the packing pattern information 127, which is 4. Here, the result of counting in the regular shaped tablet detection step S134 is equal to the number of regular shaped tablets in the packing pattern information 127. Accordingly, the tablet inspecting unit 16 determines that the inspection of the tablets in the entire medicine pack 13 is normally performed, and the processing goes to Step S05.

In the medicine pack inspecting system 10 according to Embodiment 2, based on the packing instruction information 26, at least the irregular shaped tablet patterns Bha and Dhb and the number of the irregular shaped tablets are added to the packing pattern information 127 in which the pattern and the number of tablets are shown for each kind of tablets included in the medicine pack. Moreover, the medicine pack inspecting system 10 detects the irregular shaped tablet region having a pattern matched with the irregular shaped tablet pattern within the medicine pack image for search, and determines whether the number of the irregular shaped tablet regions is equal to the number of irregular shaped tablet patterns shown in the packing pattern information. As a result, the medicine pack inspecting system 10 accurately inspects the irregular shaped tablets including the shapes of the irregular shaped tablets, and prevents an error in the irregular shaped tablet within the medicine pack 13.

In the medicine pack inspecting system 10 according to Embodiment 2, using the irregular shaped tablet pattern, the tablet inspecting unit 16 inspects the tablets including the shape of the irregular shaped tablet. Then, the tablet inspecting unit 16 obtains the medicine pack image for search from which the irregular shaped tablet region corresponding to the irregular shaped tablet is removed, and counts the number of tablet regions included in the medicine pack image for search. Thus, the number of regular shaped tablets is inspected. Thereby, the number of regular shaped tablets within the medicine pack can be accurately counted in a short time, leading to reduction in the total inspection time of the medicine pack.

This will be described. Usually, a few irregular shaped tablets and many regular shaped tablets are enclosed in the medicine pack. For this reason, when the pattern matching of the tablet patterns is performed on all kinds of tablets, the detection time will be longer as kinds of tablets are increased. Moreover, the time to count the tablet region is considerably shorter than the time to perform the pattern matching of one tablet pattern. Accordingly, the medicine pack inspecting system according to Embodiment 2 can significantly shorten the inspection time. The regular shaped tablet has a smooth and solid, disk or oval shape. Accordingly, errors in the number of tablets and breakage of the tablet are difficult to happen when the tablet packing unit 12 packs the regular shaped tablet in the medicine pack. For this reason, the tablet inspecting unit 16 can count and inspect the regular shaped tablet within the medicine pack in a short time. Moreover, the regular shaped tablet within the medicine pack may be inspected when necessary.

In the medicine pack inspecting system 10 according to Embodiment 2, based on the packing instruction information, the tablet inspecting unit 16 obtains the irregular shaped tablet pattern and the area of the irregular shaped tablet pattern for each kind of tablets packed in the medicine pack. Then, the tablet inspecting unit 16 repeatedly performs the following (a) and (b) in the ascending order of areas of the irregular shaped tablet pattern.

(a) The number of the irregular shaped tablet pattern is counted by detecting the tablet region having a pattern matched with the irregular shaped tablet pattern within the medicine pack image for search.
(b) The new medicine pack image for search is generated by deleting the tablet region detected from the medicine pack image for search.

Thereby, using the irregular shaped tablet pattern, the number and shape of the irregular shaped tablet are checked, enabling accurate inspection without an error in the shape.

Moreover, for example, when the number of tablets B in the prescription information 25 is 1.5, the tablet inspecting unit 16 produces the tablet pattern Bha and the area of the tablet pattern Bha as the packing pattern information, and produces the number of regular shaped tablets obtained by adding the number of regular shaped tablets B (which is 1). The tablet inspecting unit 16 performs the pattern matching of the tablet pattern Bha, and counts and inspects the number of regular shaped tablets including the number of regular shaped tablets B. Thus, the medicine pack inspecting system according to Embodiment 2 inspects the irregular shaped tablet B and the regular shaped tablet B in different manners even if these are the same tablet B. As a result, accurate inspection of the tablet including the shape of the irregular shaped tablet B is enabled.

In the embodiments above, the case where the same kind and same number of the tablets are enclosed in each of the medicine packs has been described, but the tablets enclosed in the medicine pack may be different among individual medicine packs. For example, the kind and number of the tablets enclosed can be different among a morning medicine pack, a noon medicine pack, and a night medicine pack. Moreover, the shape of the regular shaped tablet used for producing an irregular shaped tablet divided in half is not limited to a disk shape or an oval shape. The regular shaped tablet may have a rectangular shape or a rhombic shape. The irregular shaped tablet is not limited to the irregular shaped tablet divided in half. The irregular shaped tablet may be an irregular shaped tablet divided in thirds or quarters. Besides, various modifications can be made without changing the gist of the present invention, and are included in the present invention.

In the embodiments above, each of the components may be formed with dedicated hardware, or may be implemented by executing a software program suitable for each of the components. Each of the components may be implemented by a program executing unit such as a CPU or a processor that reads and executes a software program recorded in a recording medium such as a hard disk or a semiconductor memory.

### INDUSTRIAL APPLICABILITY

The present invention can be applied to a medicine pack inspecting system or the like used in pharmacies and hospitals that provide irregular shaped tablets to a patient with the irregular shaped tablets being enclosed in the medicine pack.

### REFERENCE SIGNS LIST

10 Medicine pack inspecting system
11 Packing instruction unit
12 Tablet packing unit
13 Medicine pack
14 Tablet dividing unit
15 Image capturing unit
16 Tablet inspecting unit
17 Lighting unit
18 Display unit
19 Transporting unit
20 Tablet information holding unit
21 Code input unit
25 Prescription information
26 Packing instruction information
27, 127 Packing pattern information
33a, 33b, 33c, 33h, 133p, 133q, 133r Medicine pack image
51, 52 Regular shape tablet A
51a, 52a, 54a, 151, 152, 154 Tablet region
53 Irregular shaped tablet B
53a, 56a, 153, 156 Irregular shaped tablet region
54, 55 Regular shaped tablet C
56 Irregular shaped tablet D
61, 62 Candidate for broken tablet region

1. A medicine pack inspecting system comprising:
a packing instruction unit configured to generate packing instruction information indicating the number of tablets of each kind to be enclosed in a medicine pack for each kind of tablets;
a tablet packing unit configured to enclose tablets in the medicine pack based on the packing instruction information;
an image capturing unit configured to capture an image of the medicine pack with the tablets being enclosed, to generate a medicine pack image; and
a tablet inspecting unit configured to inspect the number of tablets enclosed in the medicine pack by performing pattern matching using the medicine pack image and a tablet pattern shown in the packing instruction information, the tablet pattern being a shape pattern of a tablet to be enclosed in the medicine pack,
wherein the packing instruction information includes the number of divisions of an irregular shaped tablet which is a tablet divided based on the packing instruction information,
the tablet inspecting unit is configured to generate an irregular shaped tablet pattern by dividing a regular shaped tablet pattern by the number of divisions of the irregular shaped tablet included in the packing instruction information, the irregular shaped tablet pattern being a shape pattern of the irregular shaped tablet, and the regular shaped tablet pattern being a regular shape pattern of a tablet of the same kind as a kind of the irregular shaped tablet, and
the tablet inspecting unit is configured to inspect the number of the irregular shaped tablets by performing pattern matching using the irregular shaped tablet pattern and the medicine pack image when the packing instruction information includes information on the irregular shaped tablet.

2. The medicine pack inspecting system according to claim 1,
wherein the tablet inspecting unit is configured to detect candidates for a broken tablet region having an area smaller than an area of the irregular shaped tablet pattern in the medicine pack image, determine whether a total area of the candidates for a broken tablet region is equal to the area of the irregular shaped tablet pattern, and determine that the irregular shaped tablet is included in the medicine pack when the total area of the candidates for a broken tablet region is equal to the area of the irregular shaped tablet pattern.

3. The medicine pack inspecting system according to claim 2,
wherein the tablet inspecting unit is configured to inspect the number of tablet patterns selected in an ascending order of areas of the tablet pattern by performing pattern matching using the selected tablet pattern and the medicine pack image from which a region of a tablet already subjected to pattern matching is removed.

4. The medicine pack inspecting system according to claim 1,
wherein the tablet inspecting unit is configured to perform pattern matching on only the irregular shaped tablet in an ascending order of areas of the irregular shaped tablet pattern using the irregular shaped tablet pattern and the medicine pack image when the packing instruction information includes the information on the irregular shaped tablet.

5. (canceled)

6. The medicine pack inspecting system according to claim 1,
wherein the packing instruction information further includes a direction of division of the irregular shaped tablet, and
the tablet inspecting unit is configured to generate the irregular shaped tablet pattern by dividing the regular shaped tablet pattern based on the number of divisions and the direction of division of the tablet included in the packing instruction information.

7. A method of inspecting a medicine pack, the method comprising:
generating packing instruction information indicating the number of tablets of each kind to be enclosed in a medicine pack and the number of divisions of an irregular shaped tablet;
enclosing tablets in the medicine pack based on the packing instruction information;
capturing an image of the medicine pack with the tablets being enclosed, to generate a medicine pack image; and
inspecting the number of tablets enclosed in the medicine pack by performing pattern matching using the medicine pack image and a tablet pattern shown in the packing instruction information, the tablet pattern being a shape pattern of a tablet to be enclosed in the medicine pack,
wherein an irregular shaped tablet pattern is generated by dividing a regular shaped tablet pattern by the number of divisions of the irregular shaped tablet included in the packing instruction information, the irregular shaped tablet pattern being a shape pattern of the irregular shaped tablet, and the regular shaped tablet pattern being a regular shape pattern of a tablet of the same kind as a kind of the irregular shaped tablet, and
the number of irregular shaped tablets is inspected by performing pattern matching using the irregular shaped tablet pattern and the medicine pack image when the packing instruction information includes information on the irregular shaped tablet which is a tablet divided based on the packing instruction information.
